(19) United States
(12) Patent Application Publication
(10) Pub. No.: US 2026/0303270 A1
(43) Pub. Date: Oct. 1, 2026

(54) METHOD AND APPARATUS FOR HARQ PROCESS NUMBER INDICATION

(71) Applicant: LENOVO (BEIJING) LIMITED, Beijing (CN)

(72) Inventor: Haipeng Lei, Beijing (CN)

(21) Appl. No.: 18/880,423

(22) PCT Filed: Jul. 1, 2022
(86) PCT No.: PCT/CN2022/103326

§ 371 Date: Dec. 31, 2024

(51) Int. Cl. H04L 1/1867; H04W 72/1273

(52) U.S. Cl. CPC H04L 1/1896; H04W 72/1273

(57) ABSTRACT

Methods and apparatuses for HARQ process number indication are disclosed. A UE may: receive, from a BS, a DCI format scheduling a plurality of physical data channels on a plurality of cells, wherein the DCI format includes a field jointly indicating a plurality of HARQ process numbers of the plurality of physical data channels, wherein each of the plurality of HARQ process numbers corresponds to one of the plurality of physical data channels; and determine the plurality of HARQ process numbers based on the field. The UE may receive or transmit the plurality of physical data channels based on the plurality of HARQ process numbers.

### TECHNICAL FIELD

Embodiments of the present disclosure generally relate to wireless communication technology, and more particularly to hybrid automatic repeat request (HARQ) process number indication.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems, which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH).

A hybrid automatic repeat request (HARQ) scheme may be employed for the downlink and uplink (re) transmissions. According to the HARQ scheme, when the receiver fails to decode or receive data, the receiver may transmit information indicating the failure (e.g., negative acknowledgement (NACK)) to the transmitter so that the transmitter may re-transmit the corresponding data. When the receiver correctly decodes the data, the receiver may transmit information indicating the decoding success (e.g., acknowledgement (ACK)) to the transmitter. For example, a UE may transmit HARQ-ACK feedback corresponding to PDSCH transmissions through a physical uplink control channel (PUCCH) or a physical uplink shared channel (PUSCH).

There is a need for improving the HARQ scheme in a communication system.

### SUMMARY

Some embodiments of the present disclosure provide a user equipment (UE). The UE may include a transceiver, and a processor coupled to the transceiver. The processor may be configured to: receive, from a base station (BS), a downlink control information (DCI) format scheduling a plurality of physical data channels on a plurality of cells, wherein the DCI format includes a field jointly indicating a plurality of hybrid automatic repeat request (HARQ) process numbers of the plurality of physical data channels, wherein each of the plurality of HARQ process numbers corresponds to one of the plurality of physical data channels; determine the plurality of HARQ process numbers based on the field; and at least one of: receive, from the BS, the plurality of physical data channels based on the plurality of HARQ process numbers in response to the DCI format scheduling the plurality of physical data channels for downlink (DL) transmission; or transmit, to the BS, the plurality of physical data channels based on the plurality of HARQ process numbers in response to the DCI format scheduling the plurality of physical data channels for uplink (UL) transmission.

In some embodiments of the present disclosure, the field may include a first indicator indicating a reference HARQ process number for the plurality of HARQ process numbers and a second indicator indicating at least one differential value between the reference HARQ process number and at least one of the plurality of HARQ process numbers.

In some embodiments of the present disclosure, the second indicator may indicate the differential values from at least one set of possible differential values.

In some embodiments, separate sets of possible differential values may be applied to the physical data channels for DL transmission and the physical data channels for UL transmission.

In some embodiments, the at least one set of possible differential values may be configured by the BS or predefined.

In some embodiments of the present disclosure, the second indicator may include a plurality of third indicators, each of which indicates a differential value from a corresponding set of possible differential values of at least one set of possible differential values for an associated HARQ process number of the at least one of the plurality of HARQ process numbers.

In some embodiments, the plurality of third indicators is arranged in the second indicator in an order as indicated by an indicator of co-scheduled cells in the DCI format. In some embodiments, the plurality of third indicators is arranged in the second indicator according to a predefined order of indexes of the corresponding cells.

In some embodiments of the present disclosure, the processor may be configured to determine whether a number of cells of the plurality of cells is equal to or smaller than a maximum number of cells schedulable by the DCI format. In response to determining that the number of cells of the plurality of cells is equal to the maximum number of cells schedulable by the DCI format, the first indicator and the second indicator jointly indicate the plurality of HARQ process numbers.

In some embodiments, the processor may be configured to, in response to determining that the number of cells of the plurality of cells is smaller than the maximum number of cells schedulable by the DCI format, determine whether a number of bits for the field is sufficient to directly indicate the plurality of HARQ process numbers. In response to determining that the number of bits for the field is sufficient to directly indicate the plurality of HARQ process numbers, the bits for the field are used to directly indicate the plurality of HARQ process numbers. In response to determining that the number of bits for the field is not sufficient to directly indicate the plurality of HARQ process numbers, the first indicator and the second indicator jointly indicate the plurality of HARQ process numbers, or a portion of the bits for the field is used to directly indicate X HARQ process numbers of the plurality of HARQ process numbers, and the remaining bits for the field include the first indicator and the second indicator jointly indicating the remaining HARQ process numbers of the plurality of HARQ process numbers.

In some embodiments the X HARQ process numbers may be associated with X cells among the plurality of cells, the X cells are the first X cells among the plurality of cells arranged according to an order as indicated by an indicator of co-scheduled cells in the DCI format or arranged according to a predefined order of indexes of the plurality of cells.

In some embodiments, X may be equal to a largest number of HARQ process numbers that can be directly indicated along with the remaining HARQ process numbers of the plurality of HARQ process numbers that can be jointly indicated by the first indicator and the second indicator in the remaining bits of the field.

In some embodiments, determining whether the number of cells of the plurality of cells is equal to or smaller than the maximum number of cells schedulable by the DCI format may include determining whether the number of cells of the plurality of cells is equal to or smaller than the maximum number of cells schedulable by the DCI format when a dynamic switch between joint indication and direct indication for the plurality of HARQ process numbers is enabled.

In some embodiments, the dynamic switch is enabled or disabled by radio resource control (RRC) signaling. In some embodiments, the dynamic switch is predefined as enabled.

In some embodiments of the present disclosure, the field indicates a HARQ process number combination from a set of HARQ process number combinations for the plurality of HARQ process numbers.

In some embodiments, the set of HARQ process number combinations is configured by the BS or predefined.

In some embodiments, each HARQ process number combination in the set of HARQ process number combinations may include at least one HARQ process number.

In some embodiments, a size of the field is based on the number of HARQ process number combinations in the set of HARQ process number combinations.

In some embodiments, the plurality of HARQ process numbers in the HARQ process number combination is arranged according to an order as indicated by an indicator of co-scheduled cells in the DCI format or arranged according to a predefined order of indexes of the plurality of cells.

Some embodiments of the present disclosure provide a base station (BS). The BS may include a transceiver, and a processor coupled to the transceiver. The processor may be configured to: determine a plurality of hybrid automatic repeat request (HARQ) process numbers of a plurality of physical data channels; transmit, to a user equipment (UE), a downlink control information (DCI) format scheduling the plurality of physical data channels on a plurality of cells, wherein the DCI format includes a field jointly indicating a plurality of hybrid automatic repeat request (HARQ) process numbers of the plurality of physical data channels, wherein each of the plurality of HARQ process numbers corresponds to one of the plurality of physical data channels; and at least one of: transmit, to the UE, the plurality of physical data channels based on the plurality of HARQ process numbers in response to the DCI format scheduling the plurality of physical data channels for downlink (DL) transmission; or receive, from the UE, the plurality of physical data channels based on the plurality of HARQ process numbers in response to the DCI format scheduling the plurality of physical data channels for uplink (UL) transmission.

In some embodiments of the present disclosure, the field may include a first indicator indicating a reference HARQ process number for the plurality of HARQ process numbers and a second indicator indicating at least one differential value between the reference HARQ process number and at least one of the plurality of HARQ process numbers.

In some embodiments of the present disclosure, the reference HARQ process number may be: a nearest integer to an average value of the at least one HARQ process number; a median value of the at least one HARQ process number; a minimum value of the at least one HARQ process number; a maximum value of the at least one HARQ process number; or a HARQ process number of a reference physical data channel of the plurality of physical data channels scheduled on a reference cell of the plurality of cells, and the at least one of the plurality of HARQ process numbers does not include the reference HARQ process number.

In some embodiments of the present disclosure, the reference cell is a cell where the DCI format is transmitted, and the reference physical data channel is a physical data channel scheduled on the reference cell.

In some embodiments of the present disclosure, the reference cell is the first scheduled cell among the plurality of cells as indicated by an indicator of co-scheduled cells in the DCI format, and the reference physical data channel is a physical data channel scheduled on the reference cell.

In some embodiments of the present disclosure, the reference cell is a cell with the largest subcarrier spacing among the plurality of cells, and the reference physical data channel is a physical data channel scheduled on the reference cell.

In some embodiments of the present disclosure, the reference cell is a cell with the smallest subcarrier spacing among the plurality of cells, and the reference physical data channel is a physical data channel scheduled on the reference cell.

In some embodiments of the present disclosure, the reference cell is a cell where the last physical data channel of the plurality of physical data channels is transmitted, and the reference physical data channel is a physical data channel scheduled on the reference cell.

In some embodiments of the present disclosure, the reference physical data channel is the last physical data channel of the plurality of physical data channels, and the reference cell is a cell where the reference physical data channel is transmitted.

In some embodiments of the present disclosure, the reference cell is a cell where the earliest physical data channel of the plurality of physical data channels is transmitted, and the reference physical data channel is a physical data channel scheduled on the reference cell.

In some embodiments of the present disclosure, the reference physical data channel is the earliest physical data channel of the plurality of physical data channels, and the reference cell is a cell where the reference physical data channel is transmitted.

In some embodiments of the present disclosure, the reference cell is a cell with the lowest serving cell index among the plurality of cells, and the reference physical data channel is a physical data channel scheduled on the reference cell.

In some embodiments of the present disclosure, the reference cell is a cell with the highest serving cell index among the plurality of cells, and the reference physical data channel is a physical data channel scheduled on the reference cell.

In some embodiments of the present disclosure, in response to the DCI format scheduling the plurality of physical data channels for DL transmission, the reference physical data channel is a reference physical data channel for determining a slot for transmitting HARQ-ACK feedback for the plurality of physical data channels, and the reference cell is a reference cell for determining the slot for transmitting HARQ-ACK feedback for the plurality of physical data channels.

In some embodiments of the present disclosure, the second indicator indicates the differential values from at least one set of possible differential values.

In some embodiments, the processor may be configured to determine the reference HARQ process number based on the at least one set of possible differential values and the at least one HARQ process number.

In some embodiments, the at least one set of possible differential values may include a plurality of sets of possible differential values, each of which is associated with at least one of the plurality of cells. In some embodiments, the at least one set of possible differential values may include a single set of possible differential values for the plurality of cells.

In some embodiments, separate sets of possible differential values may be applied to the physical data channels for DL transmission and the physical data channels for UL transmission.

In some embodiments, the at least one set of possible differential values is predefined. In some embodiments, the processor may be configured to transmit the at least one set of possible differential values to the UE.

In some embodiments, the number of bits for the second indicator may be based on at least one of: the number of values in the at least one set of possible differential values or a maximum number of cells schedulable by the DCI format.

In some embodiments, the second indicator may include a plurality of third indicators. Each of the third indicators may indicate a differential value from a corresponding set of possible differential values of at least one set of possible differential values for an associated HARQ process number of the at least one of the plurality of HARQ process numbers.

In some embodiments, the plurality of third indicators may be arranged in the second indicator in an order as indicated by an indicator of co-scheduled cells in the DCI format. In some embodiments, the plurality of third indicators may be arranged in the second indicator according to a predefined order of indexes of the corresponding cells.

In some embodiments, the processor may be configured to determine a differential value for a HARQ process number based on the HARQ process number and the reference HARQ process number.

In some embodiments, the processor may be configured to determine whether a number of cells of the plurality of cells is equal to or smaller than a maximum number of cells schedulable by the DCI format.

In response to determining that the number of cells of the plurality of cells is equal to the maximum number of cells schedulable by the DCI format, the first indicator and the second indicator may jointly indicate the plurality of HARQ process numbers.

The processor may be configured to, in response to determining that the number of cells of the plurality of cells is smaller than the maximum number of cells schedulable by the DCI format, determine whether a number of bits for the field is sufficient to directly indicate the plurality of HARQ process numbers.

In response to determining that the number of bits for the field is sufficient to directly indicate the plurality of HARQ process numbers, the bits for the field may be used to directly indicate the plurality of HARQ process number.

In some embodiments, in response to determining that the number of bits for the field is not sufficient to directly indicate the plurality of HARQ process numbers, the first indicator and the second indicator may jointly indicate the plurality of HARQ process numbers.

In some embodiments, in response to determining that the number of bits for the field is not sufficient to directly indicate the plurality of HARQ process numbers, a portion of the bits for the field may be used to directly indicate X HARQ process numbers of the plurality of HARQ process numbers, and the remaining bits for the field may include the first indicator and the second indicator jointly indicating the remaining HARQ process numbers of the plurality of HARQ process numbers.

In some embodiments, the X HARQ process numbers may be associated with X cells among the plurality of cells. In some embodiments, the X cells may be the first (or last) X cells among the plurality of cells arranged according to an order as indicated by an indicator of co-scheduled cells in the DCI format. In some embodiments, the X cells may be the first (or last) X cells among the plurality of cells arranged according to a predefined order of indexes of the plurality of cells.

In some embodiments, X may be equal to a largest number of HARQ process numbers that can be directly indicated along with the remaining HARQ process numbers of the plurality of HARQ process numbers that can be jointly indicated by the first indicator and the second indicator in the remaining bits of the field.

In some embodiments, determining whether the number of cells of the plurality of cells is equal to or smaller than the maximum number of cells schedulable by the DCI format may include determining whether the number of cells of the plurality of cells is equal to or smaller than the maximum number of cells schedulable by the DCI format when a dynamic switch between joint indication and direct indication for the plurality of HARQ process numbers is enabled for the UE.

In some embodiments, the dynamic switch may be enabled or disabled by RRC signaling. In some embodiments, the dynamic switch may be predefined as enabled.

In some embodiments, the field may indicate a HARQ process number combination from a set of HARQ process number combinations for the plurality of HARQ process numbers.

In some embodiments, the set of HARQ process number combinations may be predefined. In some embodiments, the processor may be configured to transmit the set of HARQ process number combinations to the UE.

In some embodiments, each HARQ process number combination in the set of HARQ process number combinations may include at least one HARQ process number.

In some embodiments, the size of the field may be based on the number of HARQ process number combinations in the set of HARQ process number combinations.

In some embodiments, the plurality of HARQ process numbers in the HARQ process number combination may be arranged according to an order as indicated by an indicator of co-scheduled cells in the DCI format. In some embodiments, the plurality of HARQ process numbers in the HARQ process number combination may be arranged according to a predefined order of indexes of the plurality of cells.

Some embodiments of the present disclosure provide a method for wireless communication performed by a UE. The method may include: receiving, from a base station (BS), a downlink control information (DCI) format scheduling a plurality of physical data channels on a plurality of cells, wherein the DCI format includes a field jointly indicating a plurality of hybrid automatic repeat request (HARQ) process numbers of the plurality of physical data channels, wherein each of the plurality of HARQ process numbers corresponds to one of the plurality of physical data channels; determining the plurality of HARQ process numbers based on the field; and at least one of: receiving, from the BS, the plurality of physical data channels based on the plurality of HARQ process numbers in response to the DCI format scheduling the plurality of physical data channels for downlink (DL) transmission; or transmitting, to the BS, the plurality of physical data channels based on the plurality of HARQ process numbers in response to the DCI format scheduling the plurality of physical data channels for uplink (UL) transmission.

Some embodiments of the present disclosure provide a method for wireless communication performed by a BS. The method may include: determining a plurality of hybrid automatic repeat request (HARQ) process numbers of a plurality of physical data channels; transmitting, to a user equipment (UE), a downlink control information (DCI) format scheduling the plurality of physical data channels on a plurality of cells, wherein the DCI format includes a field jointly indicating a plurality of hybrid automatic repeat request (HARQ) process numbers of the plurality of physical data channels, wherein each of the plurality of HARQ process numbers corresponds to one of the plurality of physical data channels; and at least one of: transmitting, to the UE, the plurality of physical data channels based on the plurality of HARQ process numbers in response to the DCI format scheduling the plurality of physical data channels for downlink (DL) transmission; or receiving, from the UE, the plurality of physical data channels based on the plurality of HARQ process numbers in response to the DCI format scheduling the plurality of physical data channels for uplink (UL) transmission.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2-5 illustrate schematic diagrams of DCI format scheduling a plurality of transmissions in accordance with some embodiments of the present disclosure;

FIGS. 6 and 7 illustrate flow charts of exemplary procedures of wireless communications in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3^{rd} generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

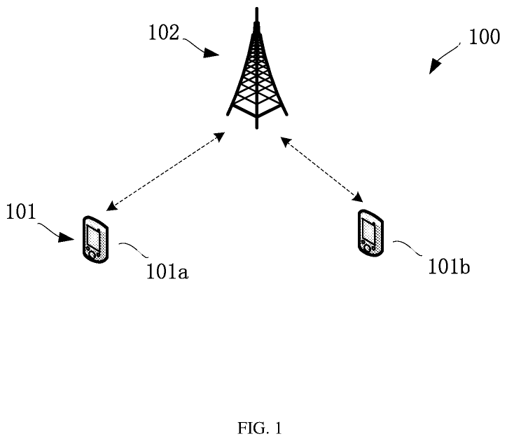

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

A communication technology (e.g., NR) may support a wide range of spectrums in different frequency ranges. For example, in the market for 5G Advanced, it is expected that the availability of the spectrum will be increased, which is possibly due to re-farming the bands originally used for previous cellular generation networks. For example, for some low frequency bands of frequency range 1 (FR1) (e.g., 410 MHz-7125 MHZ), the available spectrum bands tend to be more fragmented and scattered with a narrower bandwidth. In addition, for bands of frequency range 2 (FR2) (e.g., 24250 MHz-52600 MHZ) and some bands of FR1, the available spectrum may be wider such that an intra-band multi-carrier operation is necessary.

To meet different spectrum needs, it is important to ensure that these fragmented or scattered spectrum bands or spectrums with wider bandwidth are utilized in a more spectrum and power efficient and flexible manner, thereby providing higher throughput and decent coverage in the network.

For example, one motivation is to increase spectrum/power efficiency and flexibility on scheduling data over multiple cells including intra-band cells and inter-band cells. In some examples, scheduling mechanisms may only allow scheduling a single PUSCH or PDSCH on a single cell per a scheduling DCI. As more scattered spectrum bands or spectrums with wider bandwidth become available, it is advisable to allow simultaneous scheduling of multiple cells.

A communication system (e.g., NR) may be designed to support a maximum of 16 component carriers (CCs) in the case of carrier aggregation (CA) or a maximum of 32 CCs in the case of dual connectivity (DC). In some embodiments of the present application, in the case of CA, one DCI format can schedule at most one carrier by cross-carrier scheduling or self-scheduling. This requires much signaling overhead for PDCCHs to schedule PDSCHs or PUSCHs when the number of carriers configured for a UE is large. To reduce signaling overhead, it would be beneficial to use a single DCI format to schedule multiple PDSCHs or PUSCHs on multiple carriers configured for the UE.

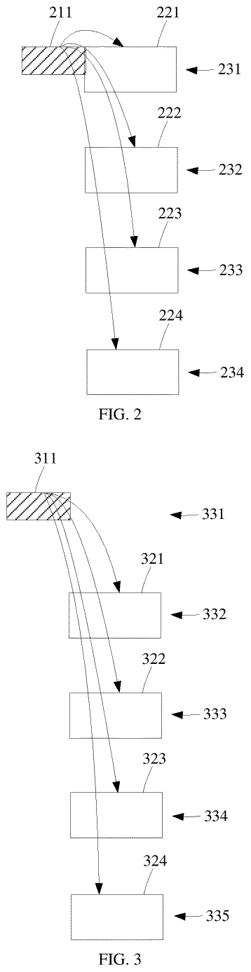

FIG. 2 illustrates a schematic diagram of a DCI format scheduling a plurality of transmissions in accordance with some embodiments of the present disclosure.

In some embodiments of the present disclosure, a plurality of CCs (e.g., including but not limited to CCs 231-234 in FIG. 2) may be configured for a UE. It should be understood that the sub-carrier spacings (SCSs) of the carriers configured for a UE may be the same or different. Each of the plurality of CCs may correspond to a respective cell (e.g., serving cell) or carrier of the UE. Each (serving cell) may be associated with a (serving) cell index.

In some embodiments of the present disclosure, instead of using separate DCI formats to respectively schedule a plurality of transmissions on a plurality of carriers, a BS may transmit a single DCI format to schedule the plurality of transmissions on the plurality of carriers. For example, as shown in FIG. 2, DCI format 211 may schedule transmissions 221-224 on CCs 231-234, where each CC carries a single transmission.

In some examples, transmissions 221-224 may be uplink transmissions, for example, uplink physical data channels such as PUSCHs. In some examples, transmissions 221-224 may be downlink transmissions, for example, downlink physical data channels such as PDSCHs.

In FIG. 2, the carrier (i.e., CC 231) on which DCI format 211 is detected carries one (e.g., transmission 221) of the scheduled transmissions. This may be referred to as self-scheduling. Other transmissions (e.g., transmissions 222-224) of the scheduled transmissions are scheduled on carriers different from the one (i.e., CC 231) on which DCI format 211 is detected. This may be referred to as cross-carrier scheduling.

Although in FIG. 2, DCI format 211 schedules a plurality of transmissions via both self-scheduling and cross-carrier scheduling, it should be understood that a DCI format may schedule a plurality of transmissions via only cross-carrier scheduling. FIG. 3 shows such an example. It also should be understood that a carrier (e.g., a CC) scheduled by a DCI format may carry more than one transmission (e.g., PDSCHs or PUSCHs) in some other embodiments of the present disclosure.

FIG. 3 illustrates a schematic diagram of a DCI format scheduling a plurality of transmissions in accordance with some embodiments of the present disclosure.

In some embodiments of the present disclosure, a plurality of CCs (e.g., including but not limited to CCs 331-335 in FIG. 3) may be configured for a UE. It should be understood that the sub-carrier spacings (SCSs) of the carriers configured for a UE may be the same or different. Each of the plurality of CCs may correspond to a respective cell (e.g., serving cell) or carrier of the UE. Each (serving cell) may be associated with a (serving) cell index.

As shown in FIG. 3, DCI format 311 may be transmitted on CC 331, and schedule transmissions 321-324 on CCs 332-335, where each CC carries a single transmission. In some examples, transmissions 321-324 may be uplink transmissions, for example, uplink physical data channels such as PUSCHs. In some examples, transmissions 321-324 may be downlink transmissions, for example, downlink physical data channels such as PDSCHs.

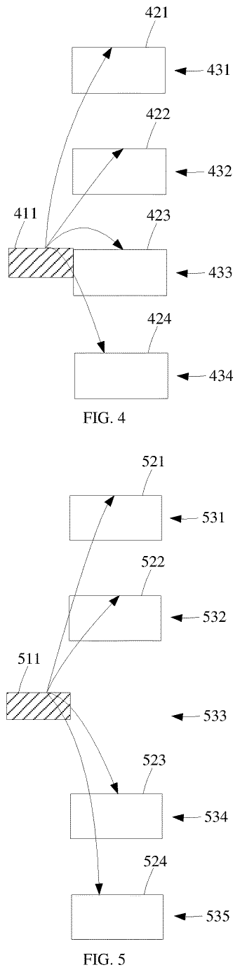

FIG. 4 illustrates a schematic diagram of a DCI format scheduling a plurality of transmissions in accordance with some embodiments of the present disclosure.

Referring to FIG. 4, a plurality of CCs (e.g., including but not limited to CCs 431-434 in FIG. 4) may be configured for a UE. It should be understood that the sub-carrier spacings (SCSs) of the carriers configured for a UE may be the same or different. Each of the plurality of CCs may correspond to a respective cell (e.g., serving cell) or carrier of the UE. Each (serving cell) may be associated with a (serving) cell index.

As shown in FIG. 4, DCI format 411 may be transmitted on CC 433, and schedule transmissions 421-424 on CCs 431-434, where each CC carries a single transmission. In some examples, transmissions 421-424 may be uplink transmissions, for example, uplink physical data channels such as PUSCHs. In some examples, transmissions 421-424 may be downlink transmissions, for example, downlink physical data channels such as PDSCHs.

FIG. 5 illustrates a schematic diagram of a DCI format scheduling a plurality of transmissions in accordance with some embodiments of the present disclosure.

In some embodiments of the present disclosure, a plurality of CCs (e.g., including but not limited to CCs 531-535 in FIG. 5) may be configured for a UE. It should be understood that the sub-carrier spacings (SCSs) of the carriers configured for a UE may be the same or different. Each of the plurality of CCs may correspond to a respective cell (e.g., serving cell) or carrier of the UE. Each (serving cell) may be associated with a (serving) cell index.

As shown in FIG. 5, DCI format 511 may be transmitted on CC 533, and schedule transmissions 521-524 on CCs 531, 532, 534, and 535, where each CC carries a single transmission. In some examples, transmissions 521-524 may be uplink transmissions, for example, uplink physical data channels such as PUSCHs. In some examples, transmissions 521-524 may be downlink transmissions, for example, downlink physical data channels such as PDSCHs.

When a DCI format schedules a single transmission on a single carrier (or single cell), the DCI format may indicate a HARQ process number from a plurality of HARQ process number for the scheduled transmission. For example, in the case of a maximum of 16 HARQ processes (e.g., for DL or UL, respectively), 4 bits may be required in the DCI format to indicate a specific HARQ process. When a DCI format schedules a plurality of transmissions on a plurality of carriers (or cells), the DCI format may indicate the respective HARQ process numbers for the plurality of transmissions. Embodiments of the present application provide solutions for indicating the HARQ process numbers for the plurality of scheduled transmissions.

In some embodiments of the present disclosure, a method similar to single-carrier (or single-cell) scheduling may be applied to HARQ process number indication in multi-cell scheduling. For example, the HARQ process number for each of the scheduled cells (or each of the scheduled transmissions on the corresponding cells) may be directly indicated in the multi-cell scheduling DCI. This method may also be referred to as “direct HARQ process number indication.”

For instance, assuming that Y cells are co-scheduled by a single DCI and a maximum of 16 HARQ processes is supported, 4Y bits may be required to indicate the HARQ process numbers for the co-scheduled cells. For example, every 4 consecutive bits of the 4Y bits may correspond to one scheduled cell (or one scheduled transmission on the cell).

According to the above embodiments, when Y is equal to 8 or 6, then 32 or 24 bits may be required for HARQ process number indication in the multi-cell scheduling DCI. Obviously, this would lead to a relatively huge signaling overhead in the scheduling DCI. Embodiments of the present application provide enhanced solutions for HARQ process number indication with reduced overhead.

In some embodiments of the present disclosure, a single HARQ process number may be indicated in the multi-cell scheduling DCI, wherein the single HARQ process number may correspond to the first scheduled cell (e.g., a first scheduled transmission on the cell) of the plurality of scheduled cells. HARQ process numbers for the remaining co-scheduled cells can be derived from the indicated value.

For example, it is assumed that a maximum of 16 HARQ processes is supported, a DCI format schedules N carriers, and the single HARQ process number field in the DCI format indicates a value of x for the first co-scheduled cell. Then, the HARQ process number for the second co-scheduled cell may be equal to (x+1) mod 16, . . . , and the HARQ process number for the last co-scheduled cell is equal to (x+N−1) mod 16.

However, considering that the HARQ process is generally managed per cell, the above HARQ process number indication method would bring scheduling restrictions to a large extent. Embodiments of the present application provide further enhanced solutions for HARQ process number indication that can reach a tradeoff between scheduling flexibility and signaling overhead reduction.

On the other hand, before detecting a DCI format, a UE needs to know the payload size of the DCI format. Since the number of co-scheduled cells is not known to a UE before successfully decoding the DCI format, it would impact the DCI payload size. Therefore, another issue to be resolved is how to determine the payload size of the DCI format.

In some embodiments, the UE may assume that the number of co-scheduled cells is the maximum number of cells that can be co-scheduled by the DCI. In response to receiving the indicator of co-scheduled cells (which may be indicated in the DCI format according to some embodiments of the present disclosure), the UE can know the number of actually co-scheduled cells. When the number of actually co-scheduled cells is smaller than the maximum number of co-schedulable cells, the bits required for HARQ process number indication may include reserved bits. Embodiments of the present application further provide solutions for using these reserved bits to achieve a more flexible scheduling. For example, as will be described in detail in the following embodiments, a dynamic switch between a per-cell independent HARQ process number indication and a per-cell joint HARQ process number indication based on the number of actually co-scheduled cells may be supported.

More details on the embodiments of the present disclosure will be illustrated in the following text in combination with the appended drawings. It should be noted that the solutions of the present disclosure can be applied to both downlink transmissions (e.g., PDSCHs) and uplink transmissions (e.g., PUSCHs) scheduled by a DCI format.

In some embodiments of the present disclosure, in the case that a single DCI format can schedule a plurality of physical data channels (e.g., for downlink or uplink transmission) on a plurality of cells (may also be called “serving cells” or carriers), a joint HARQ process number indication method may be employed. For example, a field (hereinafter referred to as “joint HARQ process number indication field”) in the DCI format may jointly indicate a plurality of HARQ process numbers of the plurality of physical data channels, wherein each of the plurality of HARQ process numbers may correspond to one physical data channel of the plurality of physical data channels.

From the perspective of a UE, in response to receiving the DCI format from a BS, the UE may determine the plurality of HARQ process numbers based on the joint HARQ process number indication field in the DCI format. In the case of the DCI format scheduling the plurality of physical data channels for DL transmission (e.g., PDSCHs), the UE may receive, from the BS, the plurality of physical data channels based on the plurality of HARQ process numbers. In the case of the DCI format scheduling the plurality of physical data channels for UL transmission (e.g., PUSCHs), the UE may transmit, to the BS, the plurality of physical data channels based on the plurality of HARQ process numbers.

In some embodiments of the present disclosure, the joint HARQ process number indication field may include an indicator (denoted as “indicator #1”) indicating a reference HARQ process number for the plurality of HARQ process numbers and an indicator (denoted as “indicator #2”) indicating at least one differential value between the reference HARQ process number and at least one HARQ process number of the plurality of HARQ process numbers.

In some embodiments of the present disclosure, indicator #2 may indicate the differential values between the reference HARQ process number and the HARQ process numbers of all the co-scheduled physical data channels. That is, the at least one HARQ process number may be the plurality of HARQ process numbers. The reference HARQ process number may or may not be a HARQ process number of the plurality of HARQ process numbers for the plurality of co-scheduled physical data channels. Various methods may be employed for determining the reference HARQ process number and will be described in the following text. In this way, the HARQ process number for each of the plurality of co-scheduled physical data channels can be derived based on the reference HARQ process number and the corresponding differential value.

As will be described later, in the case that a dynamic switch between joint indication and direct indication is enabled, the at least one HARQ process number may be a subset of plurality of HARQ process numbers under certain scenarios. In these scenarios, the descriptions regarding indicator #1 and indicator #2 may be similarly applied which can be easily conceived of by persons skilled in the art.

In some embodiments, at least one set of possible differential values may be configured for the UE by, for example, radio resource control (RRC) signaling, or predefined in, for example, standards for multi-cell scheduling. For example, a single set of possible differential values may be configured or predefined for all the co-scheduled cells. For example, at least one set of possible differential values may include a plurality of sets of possible differential values, each of which may be associated with at least one of the co-scheduled cells. For instance, separate sets of possible differential values may be configured or predefined for different co-scheduled cells. That is, a set of possible differential values may be configured per cell. For instance, two or more co-scheduled cells may share the same set of possible differential values.

In some embodiments, separate sets of possible differential values may be applied to the physical data channels for DL transmission (e.g., PDSCHs) and the physical data channels for UL transmission (e.g., PUSCHs). For example, at least one set of possible differential values may be configured or predefined for PDSCHs, and at least one other set of possible differential values may be configured or predefined for PUSCHs.

Indicator #2 may indicate the differential values from the at least one set of possible differential values. For example, for each of the plurality of co-scheduled physical data channels, indicator #2 may include at least one bit to indicate a differential value from a corresponding set of possible differential values of the at least one set of possible differential values. The same or different numbers of bits may be used for indicating the differential values for respective co-scheduled physical data channels. For example, the number of bits for indicating a differential value may be dependent on the number of values in the corresponding set of possible differential values. For example, the number of bits for indicating a differential value may be dependent on a maximum value among the numbers of values in the at least one set of possible differential values.

The number of bits for indicator #1 (denoted as “K”) may be dependent on the maximum number of HARQ processes among the co-scheduled cells. For example, in the case that a maximum of 16 HARQ processes is supported, indicator #1 may include at least 4 bits.

The number of bits for indicator #2 may be dependent on at least one of: the number of values in the at least one set of possible differential values or a maximum number of cells schedulable by a single DCI format. For example, assuming that a single set of possible differential values is employed or each of the at least one set of possible differential values includes the same number of values, the number of bits for indicator #2 may be equal to M*[log₂ N], where N is the number of values in the at least one set of possible differential values (so that [log₂ N] bits are required for indicating one value from the set of possible differential values for one of the co-scheduled physical data channels), and M is the maximum number of cells which can be scheduled by a single DCI format for the UE. In some examples, every [log₂ N] consecutive bits of the M*[log₂ N] bits of indicator #2 may correspond to one of the maximum M co-schedulable physical data channels. The total number of bits for the joint HARQ process number indication field in the DCI format may thus be equal to K+M*[log₂ N]. For determining the payload size of the DCI format, a UE may thus assume that K+M*[log₂ N] bits are required for indicating the plurality of HARQ process numbers for the plurality of physical data channels co-scheduled by the DCI format.

To put the above descriptions another way, indicator #2 may include a plurality of indicators (denoted as indicators #3), each of which may indicate a differential value from a corresponding set of possible differential values of the at least one set of possible differential values for an associated HARQ process number. In other words, indicator #2 (e.g., M*[log₂ N] bits) can be regarded as M indicators #3 and each indicator may include a number of consecutive bits (e.g., [log₂ N]). The M indicators may correspond to the maximum M co-schedulable physical data channels in a one-to-one mapping manner. That is, each of the M indicators may correspond to one of the maximum M co-schedulable physical data channels.

In some examples, the M indicators in indicator #2 may be ordered in the same order as the co-scheduled cells. In some examples, the co-scheduled cells and the M indicators may be ordered as indicated by an indicator of co-scheduled cells in the DCI. In some examples, the co-scheduled cells and the M indicators may be ordered based on a predefined order (e.g., an ascending or descending order) of the corresponding cell indexes. For example, a first indicator #3 to the last indicator #3 may indicate the differential values between the reference HARQ process number and the HARQ process numbers from the first co-scheduled physical data channels to the last co-scheduled physical data channels of the maximum M co-scheduled physical data channels.

Each indicator #3 may have the same or a different size (e.g., number of bits). For example, the size of indicator #3 may be dependent on the number of values in the corresponding set of possible differential values. For example, the size of indicator #3 may be dependent on a maximum value among the numbers of values in the at least one set of possible differential values.

Various methods may be employed to determine the value of the reference HARQ process number. When determining the reference HARQ process number, a BS should ensure there are corresponding differential values in the at least one set of possible differential values for indicating the plurality of HARQ process numbers of the plurality of co-scheduled physical data channels, so that the HARQ process numbers for all the co-scheduled physical data channels can be indicated by the reference HARQ process number and the corresponding differential values. For example, a HARQ process number may be determined based on a sum of the reference HARQ process number and the corresponding differential value.

How to calculate the reference HARQ process number may be fully dependent on, for example, an algorithm at the BS and/or the at least one set of possible differential values. The reference HARQ process number may or may not be a HARQ process number of a co-scheduled physical data channel. For example, the reference HARQ process number may be: the nearest integer to the average value of the HARQ process numbers of the co-scheduled physical data channels, a median value of the HARQ process numbers of the co-scheduled physical data channels; the minimum value of the HARQ process numbers of the co-scheduled physical data channels; or the maximum value of the HARQ process numbers of the co-scheduled physical data channels.

For example, when the at least one set of possible differential values includes positive integer values and negative integer values, the reference HARQ process number can be determined by the BS as the nearest integer value to the average value of the HARQ process numbers of the co-scheduled physical data channels, or a median value of the HARQ process numbers of the co-scheduled physical data channels. In this way, the HARQ process number for each of the co-scheduled physical data channels can be indicated by the reference HARQ process number and the corresponding differential value.

For example, when the at least one set of possible differential values includes only non-negative integer values, the reference HARQ process number can be determined by the BS as the minimum value of the HARQ process numbers of the co-scheduled physical data channels. In this way, the HARQ process number for each of the co-scheduled physical data channels can be indicated by the reference HARQ process number and the corresponding non-negative differential value.

For example, when the at least one set of possible differential values includes only non-positive integer values, the reference HARQ process number can be determined by the BS as the maximum value of the HARQ process numbers of the co-scheduled physical data channels. In this way, the HARQ process number for each of the co-scheduled physical data channels can be indicated by the reference HARQ process number and the corresponding non-positive differential value.

At the BS side, the BS may determine the value of the reference HARQ process number according to its scheduling policy and differential values for the co-scheduled physical data channels, and then indicate these values via the joint HARQ process number indication field (e.g., a total of K+M*[log₂ N] bits as described above) in the DCI format.

At the UE side, in response to the reception of the DCI format, the UE may determine the value of the reference HARQ process number, and then determine the HARQ process number of each of the co-scheduled physical data channels based on the reference HARQ process number and the corresponding differential value.

For example, assuming that a set of possible differential values {−1, 0, +1, +2} and 16 HARQ processes are configured per co-scheduled cell, then 4 bits (i.e., K=4) may be needed to indicate the reference HARQ process number and 2 bits (i.e., [log₂ 4]) may be needed to indicate one of the four differential values in the set of possible differential values for each of the co-scheduled physical data channels. For example, two bits as “00” may indicate the first value of the set (i.e., −1), two bits as “01” may indicate the second value of the set (i.e., 0), two bits as “10” may indicate the third value of the set (i.e., +1), and two bits as “11” may indicate the fourth value of the set (i.e., +2). When 4 cells are co-scheduled by a DCI format, denoting the value of the reference HARQ process number as h and the four HARQ process numbers for the 4 cells as h1, h2, h3 and h4 respectively, in the case that h1=1, h2=2, h3=3, h4=4, the BS can indicate the value of the reference HARQ process number as 2, which is the average value of h1, h2, h3 and h4, so that the values of h1-h, h2-h, h3-h and h4-h can be indicated in the DCI format by pointing out the differential values from the set of possible differential values, respectively. For example, the differential value for the HARQ process number of the 1^{st} scheduled physical data channel is −1, which can be indicated by two bits as “00”, the differential value for the HARQ process number of the 2^{nd} scheduled physical data channel is 0, which can be indicated by two bits as “01”, the differential value for the HARQ process number of the 3^{rd} scheduled physical data channel is +1, which can be indicated by two bits as “10”, and the differential value for the HARQ process number of the 4^{th} scheduled physical data channel is +2, which can be indicated by two bits as “11”. In this example, a total of 12 bits may be needed, i.e., 4 bits indicating the value of the reference HARQ process number, and 8 bits indicating the 4 differential values for 4 HARQ process numbers of the 4 co-scheduled physical data channels with every two consecutive bits corresponding to one of the 4 co-scheduled physical data channels.

For example, assuming that a set of possible differential values is {0, +1, +2, +3} and 16 HARQ processes are configured per co-scheduled cell, then 4 bits (i.e., K=4) may be needed to indicate the reference HARQ process number and 2 bits (i.e., [log₂ 4]) may be needed to indicate one of the four differential values in the set of possible differential values for each of the co-scheduled physical data channels. For example, two bits as “00” may indicate the first value of the set (i.e., 0), two bits as “01” may indicate the second value of the set (i.e., +1), two bits as “10” may indicate the third value of the set (i.e., +2), and two bits as “11” may indicate the fourth value of the set (i.e., +3). When 4 cells are co-scheduled by a DCI format, denoting the value of the reference HARQ process number as h and the four HARQ process numbers for the 4 cells as h1, h2, h3 and h4 respectively, in the case that h1=1, h2=2, h3=3, h4-4, the BS can indicate the value of the reference HARQ process number as 1, which 1 is the minimum value of h1, h2, h3 and h4, so that the values of h1-h, h2-h, h3-h and h4-h can be indicated in the DCI format by pointing out the differential values from the set of possible differential values, respectively. For example, the differential value for the HARQ process number of the 1^{st} scheduled physical data channel is 0, which can be indicated by two bits as “00”, the differential value for the HARQ process number of the 2^{nd} scheduled physical data channel is +1, which can be indicated by two bits as “01”, the differential value for the HARQ process number of the 3^{rd} scheduled physical data channel is +2, which can be indicated by two bits as “10”, and the differential value for the HARQ process number of the 4th scheduled physical data channel is +3, which can be indicated by two bits as “11”. In this example, a total of 12 bits may be needed, i.e., 4 bits indicating the value of the reference HARQ process number, and 8 bits indicating the 4 differential values for 4 HARQ process numbers of the 4 co-scheduled physical data channels, with every two consecutive bits of the 8 bits corresponding to one of the 4 co-scheduled physical data channels.

For example, assuming that a set of possible differential values is {−3, −2, −1, 0} and 16 HARQ processes are configured per co-scheduled cell, then 4 bits (i.e., K=4) may be needed to indicate the reference HARQ process number and 2 bits (i.e., [log₂ 4]) may be needed to indicate one of the four differential values in the set of possible differential values for each of the co-scheduled physical data channels. For example, two bits as “00” may indicate the first value of the set (i.e., −3), two bits as “01” may indicate the second value of the set (i.e., −2), two bits as “10” may indicate the third value of the set (i.e., −1), and two bits as “11” may indicate the fourth value of the set (i.e., 0). When 4 cells are co-scheduled by a DCI format, denoting the value of the reference HARQ process number as h and the four HARQ process numbers for the 4 cells as h1, h2, h3 and h4 respectively, in the case that h1=1, h2=2, h3=3, h4-4, the BS can indicate the value of the reference HARQ process number as 4, which is the maximum value of h1, h2, h3 and h4, so that the values of h1-h, h2-h, h3-h and h4-h can be indicated in the DCI format by pointing out the differential values from the set of possible differential values, respectively. For example, the differential value for HARQ process number of the 1^{st} scheduled physical data channel is −3, which can be indicated by two bits as “00”, the differential value for HARQ process number of the 2^{nd} scheduled physical data channel is −2, which can be indicated by two bits as “01”, the differential value for HARQ process number of the 3^{rd} scheduled physical data channel is −1, which can be indicated by two bits as “10”, and the differential value for HARQ process number of the 4th scheduled physical data channel is 0, which can be indicated by two bits as “11”. In this example, a total of 12 bits may be needed, i.e., 4 bits indicating the value of the reference HARQ process number, and 8 bits indicating the 4 differential values for 4 HARQ process numbers of the 4 co-scheduled physical data channels with every two consecutive bits corresponding to one of the 4 co-scheduled physical data channels.

In some embodiments of the present disclosure, considering the number of actually co-scheduled cells by a DCI format may be smaller than the maximum number of cells schedulable by the DCI format, a dynamic switch between joint indication and direct indication may be supported to allow a more flexible scheduling. Direct indication means that the value of a HARQ process number of a scheduled cell or scheduled physical data channel is directly indicated in the DCI format.

In some embodiments, whether the dynamic switch is enabled or disabled may be configured by RRC signaling. In some embodiments, the dynamic switch may be predefined as enabled (or supported) in, for example, a standard. In some embodiments, when the dynamic switch is disabled of unsupported, the joint indication as described above with respect to indicator #1 and indicator #2 may be applied. When the dynamic switch is enabled, the bits for the joint HARQ process number indication field may be used for only joint indication, only direct indication, or a combination of joint indication and direct indication under different scenarios.

In some embodiments of the present disclosure, when a DCI format only schedules a single cell for transmitting a single physical data channel (e.g., PDSCH or PUSCH), the HARQ process number of the scheduled single physical data channel is directly indicated in the joint HARQ process number indication field. For example, the single HARQ process number may occupy 4 bits and the remaining unused bits for the field may be reserved in the DCI format.

The dynamic switch, if enabled, may be implemented in various manners.

In some embodiments of the present disclosure, a UE may determine the number of actually co-scheduled cells based on the DCI format (e.g., an indicator of co-scheduled cells in the DCI format). When the UE determines that the number of actually co-scheduled cells is equal to the maximum number of co-schedulable cells for the UE, the UE assumes that only the joint indication method is adopted. That is, indicator #1 and indicator #2 jointly indicate the plurality of HARQ process numbers of the plurality of co-scheduled physical data channels.

When the UE determines that the number of actually co-scheduled cells is smaller than the maximum number of co-schedulable cells for the UE and the number of bits for the joint HARQ process number indication field (e.g., K+M*[log₂ N] bits) is sufficient to directly indicate the HARQ process numbers of all co-scheduled physical data channels, the UE assumes that only the direct indication method is adopted. That is, the bits for the joint HARQ process number indication field are used to directly indicate the plurality of HARQ process numbers of the plurality of co-scheduled physical data channels.

For example, when K+M*[log₂ N]>=k₁+k₂+ . . . +kₘ, wherein m is the number of actually co-scheduled cells by the DCI format and kᵢ (i∈{1, 2, . . . , m}) is the number of bits required for indicating the HARQ process number of the i^{th} co-scheduled physical data channel of the m actually co-scheduled physical data channels on the m actually co-scheduled cells, the joint HARQ process number indication field directly indicates the HARQ process numbers of the m actually co-scheduled physical data channels. For example, in the case that the number of bits required for indicating the HARQ process number of each of the actually co-scheduled physical data channels (denotes as “k”) are the same (e.g., the maximum HARQ process supported by each co-scheduled cell are the same), when K+M*[log₂ N]>=k*m, the joint HARQ process number indication field directly indicates the HARQ process numbers of the actually co-scheduled physical data channels.

In some embodiments of the present disclosure, when the UE determines that the number of actually co-scheduled cells is smaller than the maximum number of co-scheduled cells for the UE while the number of bits for the joint HARQ process number indication field is not sufficient to directly indicate the HARQ process numbers of all co-scheduled physical data channels (e.g., K+M*[log₂ N]<k₁+k₂+ . . . +kₘ, or K+M*[log₂ N]<k*m), the UE assumes that only the joint indication method is adopted. That is, indicator #1 and indicator #2 jointly indicate the plurality of HARQ process numbers of the plurality of co-scheduled physical data channels.

In some embodiments of the present disclosure, when the UE determines that the number of actually co-scheduled cells is smaller than the maximum number of co-scheduled cells for the UE while the number of bits for the joint HARQ process number indication field is not sufficient to directly indicate the HARQ process numbers of all co-scheduled physical data channels (e.g., K+M*[log₂ N]<k₁+k₂+ . . . +kₘ, or K+M*[log₂ N]<k*m), the UE assumes that a combination of the joint indication method and the direct indication method is adopted.

For example, a portion of the bits for the joint HARQ process number indication field may be used to directly indicate a number of HARQ process numbers (e.g., X HARQ process numbers) of the plurality of HARQ process numbers of all co-scheduled physical data channels. The remaining bits for the field may include indicator #1 and indicator #2 jointly indicating the remaining HARQ process numbers (e.g., m−X HARQ process numbers) of the plurality of HARQ process numbers.

In some embodiments, the X HARQ process numbers may be associated with X cells among the plurality of actually co-scheduled cells (or X physical data channels of the plurality of co-scheduled physical data channels). In some examples, the X cells may be the first (or last) X cells among the actually co-scheduled cells arranged according to an order as indicated by an indicator of co-scheduled cells in the DCI format or arranged according to a predefined order (e.g., an ascending or descending order) of indexes of the plurality of actually co-scheduled cells.

In some embodiments, X may be equal to the largest number of HARQ process numbers that can be directly indicated along with the remaining HARQ process numbers of the plurality of HARQ process numbers that can be jointly indicated by indicator #1 and indicator #2 in the remaining bits of the field. For example, X may be the largest integer value satisfying K+M*[log₂ N]>=k₁+k₂+ . . . +kₓ+K+(m−X)*[log₂ N] or K+M*[log₂ N]>=k*X+K+(m−X)*[log₂ N].

For example, assuming M=4, N=4, K=4, then K+M*[log₂ N]=12. When m=4, then the UE assumes that the joint indication method for indicating the HARQ process numbers of co-scheduled physical data channels is adopted. That is, indicator #1 and indicator #2 jointly indicate the four HARQ process numbers for the four co-scheduled physical data channels. When m=3 and k=4, then K+M*[log₂ N]=k*m. The UE assumes that the direct indication method is adopted. That is, the joint HARQ process number indication field directly indicates the three HARQ process numbers for the three co-scheduled physical data channels. When m=2 and k=4, then K+M*[log₂ N]>k*m. The UE assumes that the direct indication method is adopted. That is, the joint HARQ process number indication field directly indicates the two HARQ process numbers for the two co-scheduled physical data channels, and the unused K+M*[log₂ N]−k*m bits are reserved.

For example, assuming M=6, N=4, K=4, then K+M*[log₂ N]=16. When m=5 and k=4, then K+M*[log₂ N]<k*m. In some embodiments, the UE assumes that the joint indication method for indicating the five HARQ process numbers of five co-scheduled physical data channels is adopted. That is, indicator #1 and indicator #2 jointly indicate the five HARQ process numbers of the five co-scheduled physical data channels. In some other embodiments, the UE assumes that a combination of the joint indication method and the direct indication method is adopted. For example, the largest integer value of X which satisfies the equation of K+M*[log₂ N]>=k*X+K+(m−X)*[log₂ N] is X=1, so the joint HARQ process number indication field directly indicates one HARQ process number of the five HARQ process numbers of the five co-scheduled physical data channels and includes indicator #1 and indicator #2 for indicating the remaining four HARQ process numbers.

In some examples, the single directly indicated HARQ process number may correspond to the first scheduled cell (or the first physical data channel) among the five co-scheduled cells (or the five physical data channels) as indicated by the indicator of co-scheduled cells in the DCI format. In some examples, the single directly indicated HARQ process number may correspond to a scheduled cell having the highest or lowest cell index among the five co-scheduled cells.

In some embodiments of the present disclosure, the reference HARQ process number may be a HARQ process number of a reference physical data channel scheduled on a reference cell. The reference physical data channel is one of the plurality of co-scheduled physical data channels and the reference cell is the one of the plurality of co-scheduled cells. Indicator #2 may indicate the differential values between the reference HARQ process number and the HARQ process numbers of all the co-scheduled physical data channels except the reference physical data channel. That is, the at least one HARQ process number may be the plurality of HARQ process numbers of the plurality of physical data channels excluding the reference HARQ process number. Various methods may be employed for determining the reference physical data channel and reference cell, and will be described in the following text. In this way, the HARQ process number of each of the plurality of co-scheduled physical data channels except the HARQ process number of the reference physical data channel (which is indicated by the reference HARQ process number) can be derived based on the reference HARQ process number and the corresponding differential value.

As will be described later, in the case of a dynamic switch between joint indication and direct indication is enabled, the at least one HARQ process number may be a subset of the HARQ process numbers of all the co-scheduled physical data channels except the reference physical data channel under certain scenarios. In these scenarios, the descriptions regarding indicator #1 and indicator #2 may be similarly applied which can be easily conceived of by persons skilled in the art.

In some embodiments, at least one set of possible differential values may be configured for the UE by, for example, RRC signaling, or predefined in, for example, standards for multi-cell scheduling. For example, a single set of possible differential values may be configured or predefined for all the co-scheduled cells. For example, at least one set of possible differential values may include a plurality of sets of possible differential values, each of which may be associated with at least one of the co-scheduled cells. For instance, separate sets of possible differential values may be configured or predefined for different co-scheduled cells. That is, a set of possible differential values may be configured per cell. For instance, two or more co-scheduled cells may share the same set of possible differential values.

In some embodiments, separate sets of possible differential values may be applied to the physical data channels for DL transmission (e.g., PDSCHs) and the physical data channels for UL transmission (e.g., PUSCHs). For example, at least one set of possible differential values may be configured or predefined for PDSCHs, and at least one other set of possible differential values may be configured or predefined for PUSCHs.

Indicator #2 may indicate the differential values from the at least one set of possible differential values. For example, for each of the plurality of co-scheduled physical data channels except the reference physical data channel, indicator #2 may include at least one bit to indicate a differential value from a corresponding set of possible differential values of the at least one set of possible differential values. The same or different numbers of bits may be used for indicating the differential values for respective co-scheduled physical data channels. For example, the number of bits for indicating a differential value may be dependent on the number of values in the corresponding set of possible differential values. For example, the number of bits for indicating a differential value may be dependent on a maximum value among the numbers of values in the at least one set of possible differential values.

The number of bits for indicator #1 (denoted as “K”) may be dependent on the maximum number of HARQ processes among the co-scheduled cells. For example, in the case that a maximum of 16 HARQ processes is supported, indicator #1 may include at least 4 bits.

The number of bits for indicator #2 may be dependent on at least one of: the number of values in the at least one set of possible differential values or a maximum number of cells schedulable by a single DCI format. For example, assuming that a single set of possible differential values is employed or each of the at least one set of possible differential values includes the same number of values, the number of bits for indicator #2 may be equal to (M′−1)*[log₂ N′], where N′ is the number of values in the at least one set of possible differential values (so that [log₂ N′] bits are required for indicating one value from the set of possible differential values for one of the co-scheduled physical data channels except the reference data channel), and M′ is the maximum number of cells which can be scheduled by a single DCI format for the UE. In some examples, every [log₂ N′] consecutive bits of the (M′−1)*[log₂ N′] bits of indicator #2 may correspond to one of the M′−1 co-schedulable physical data channels (i.e., the M′ co-schedulable physical data channels except the reference data channel). The total number of bits for the joint HARQ process number indication field in the DCI format may thus be equal to K′+(M′−1)*[log₂ N′]. For determining the payload size of the DCI format, a UE may thus assume that K′+(M′−1)*[log₂ N′] bits are required for indicating the plurality of HARQ process numbers for the plurality of physical data channels co-scheduled by the DCI format.

To put the above descriptions another way, indicator #2 may include a plurality of indicators (denoted as indicators #3), each of which may indicate a differential value from a corresponding set of possible differential values of the at least one set of possible differential values for an associated HARQ process number. In other words, indicator #2 (e.g., (M′−1)*[log₂ N′] bits) can be regarded as M′−1 indicators #3 and each indicator #3 may include a number of consecutive bits (e.g., [log₂ N′]). The M′−1 indicators may correspond to the M′−1 co-schedulable physical data channels (i.e., the M′ co-schedulable physical data channels except the reference data channel) in a one-to-one mapping manner. That is, each of the M′−1 indicators may correspond to one of the M′−1 co-schedulable physical data channels.

In some examples, the M′−1 indicators in indicator #2 may be ordered in the same order as the co-scheduled cells. In some examples, the co-scheduled cells and the M′−1 indicators may be ordered as indicated by an indicator of co-scheduled cells in the DCI. In some examples, the co-scheduled cells and the M′−1 indicators may be ordered based on a predefined order (e.g., an ascending or descending order) of the corresponding cell indexes. For example, a first indicator #3 to the last indicator #3 may indicate the differential values between the reference HARQ process number and the HARQ process numbers from the first co-scheduled physical data channels to the last co-scheduled physical data channels of the maximum M′ co-scheduled physical data channels except the reference data channel.

Each indicator #3 may have the same or a different size (e.g., number of bits). For example, the size of indicator #3 may be dependent on the number of values in the corresponding set of possible differential values. For example, the size of indicator #3 may be dependent on a maximum value among the numbers of values in the at least one set of possible differential values.

Various methods may be employed to determine the reference physical data channel and the reference cell. It should be noted that in some examples, the reference cell is first determined or defined and then the physical data channel scheduled on the reference cell is determined or defined as the reference physical data channel; and in some examples, the reference physical data channel is first determined or defined and then the cell which carries the reference physical data channel is determined or defined as the reference cell, which are all covered by the scope of the disclosure.

For example, in some embodiments, the reference cell is a cell where the DCI format is transmitted, and the reference physical data channel is the physical data channel scheduled on the reference cell.

In some embodiments, the reference cell is the first scheduled cell among the plurality of co-scheduled cells as indicated by an indicator of co-scheduled cells in the DCI format, and the reference physical data channel is the physical data channel scheduled on the reference cell.

In some embodiments, the reference cell is a cell with the largest subcarrier spacing among the plurality of co-scheduled cells, and the reference physical data channel is the physical data channel scheduled on the reference cell.

In some embodiments, the reference cell is a cell with the smallest subcarrier spacing among the plurality of co-scheduled cells, and the reference physical data channel is the physical data channel scheduled on the reference cell.

In some embodiments, the reference cell is a cell where the last physical data channel of the plurality of co-scheduled physical data channels is transmitted, and the reference physical data channel is the physical data channel scheduled on the reference cell. In some embodiments, the last physical data channel may mean that the physical data channel ends later than any other physical data channel of the plurality of co-scheduled physical data channels.

In some embodiments, the reference physical data channel is the last physical data channel of the plurality of co-scheduled physical data channels. In some embodiments, the last physical data channel may mean that the physical data channel ends later than any other physical data channel of the plurality of co-scheduled physical data channels. The reference cell is a cell where the reference physical data channel (e.g., the last physical data channel) is transmitted.

In some embodiments, the reference cell is a cell where the earliest physical data channel of the plurality of co-scheduled physical data channels is transmitted, and the reference physical data channel is a physical data channel scheduled on the reference cell. In some embodiments, the earliest physical data channel may mean that the physical data channel starts earlier than any other physical data channel of the plurality of co-scheduled physical data channels.

In some embodiments, the reference physical data channel is the earliest physical data channel of the plurality of co-scheduled physical data channels. In some embodiments, the earliest physical data channel may mean that the physical data channel starts earlier than any other physical data channel of the plurality of co-scheduled physical data channels. The reference cell is a cell where the reference physical data channel (e.g., the earliest physical data channel) is transmitted.

In some embodiments, the reference cell is a cell with the lowest cell index (or serving cell index) among the plurality of co-scheduled cells, and the reference physical data channel is the physical data channel scheduled on the reference cell.

In some embodiments, the reference cell is a cell with the highest cell index (or serving cell index) among the plurality of co-scheduled cells, and the reference physical data channel is the physical data channel scheduled on the reference cell.

In some embodiments, in the case that the DCI format schedules the plurality of physical data channels for DL transmission, the reference physical data channel associated with the reference HARQ process number is a reference physical data channel (e.g., PDSCH) for determining the slot (e.g., PUCCH slot) for transmitting HARQ acknowledgement (HARQ-ACK) feedback for the plurality of physical data channels. The reference cell associated with the reference HARQ process number is a reference cell for determining the slot (e.g., PUCCH slot) for transmitting HARQ-ACK feedback for the plurality of physical data channels.

At the BS side, the BS may determine the reference cell and reference physical data channel firstly according to one of above methods, and then indicate the HARQ process number of the reference physical data channel by indicator #1 and differential values for the remaining co-scheduled physical data channels (e.g., all of the co-scheduled physical data channels except the reference physical data channel) by indicator #2.

At the UE side, in response to the reception of the DCI format, the UE may firstly determine the reference cell and reference physical data channel according to the same method, and then determine the value of the reference HARQ process number and each of the co-scheduled physical data channels based on the reference HARQ process number and the corresponding differential values.

For example, the reference cell may be defined as the cell where the DCI format is transmitted and the reference physical data channel may be the scheduled physical data channel on the reference cell. Referring back to FIG. 2, the reference cell is CC 231 and the reference physical data channel is transmission 221 on CC 231. Assuming that a set of possible differential values is {0, +1, +2, +3} and 16 HARQ processes are configured per co-scheduled cell, then 4 bits may be needed to indicate the reference HARQ process number and 2 bits may be needed to indicate one of the four differential values for each of the co-scheduled physical data channels. For example, two bits as “00” may indicate the first value of the set (i.e., 0), two bits as “01” may indicate the second value of the set (i.e., +1), two bits as “10” may indicate the third value of the set (i.e., +2), and two bits as “11” may indicate the fourth value of the set (i.e., +3). When 4 cells (e.g., CC 231-CC 234 in FIG. 2) are co-scheduled by a DCI format on CC 231, denoting the value of the reference HARQ process number as h, which is also the HARQ process number for reference physical data channel on the reference cell (e.g., transmission 221 on CC 231 in FIG. 2), and h2, h3 and h4 are three HARQ process numbers for the remaining three scheduled cells (e.g., CC 232-CC 234 in FIG. 2) respectively, in the case that h=1, h2=2, h3=3, h4=4, the BS can indicate the value of the reference HARQ process number as 1, so that the values of h2-h, h3-h and h4-h can be indicated in the DCI format by pointing out the differential values from the set of possible differential values, respectively. For example, the differential value for HARQ process number of the 2^{nd} scheduled physical data channel (e.g., transmission 222 on CC 232 in FIG. 2) is +1, which can be indicated by two bits as “01”, the differential value for HARQ process number of the 3^{rd} scheduled physical data channel (i.e., transmission 223 on CC 233 in FIG. 2) is +2, which can be indicated by two bits as “10”, and the differential value for HARQ process number of the 4^{th} scheduled physical data channel (i.e., transmission 224 on CC 234 in FIG. 2) is +3, which can be indicated by two bits as “11”. In this example, a total of 10 bits may be needed, i.e., 4 bits indicating the value of the reference HARQ process number, and 6 bits indicating the 3 differential values for 3 HARQ process numbers of the 4 co-scheduled physical data channels except the reference physical data channel, with every two consecutive bits of the 6 bits corresponding to one of the 4 co-scheduled physical data channels except the reference physical data channel.

For example, the reference cell may be defined as the first scheduled cell indicated by the indicator of co-scheduled cells in the DCI format and the reference physical data channel may be the scheduled physical data channel on the reference cell. Referring back to FIG. 3, the reference cell may be CC 332 and the reference physical data channel is transmission 321 on CC 332. Assuming that a set of possible differential values is {0, +1, +2, +3} and 16 HARQ processes are configured per co-scheduled cell, then 4 bits may be needed to indicate the reference HARQ process number and 2 bits may be needed to indicate one of the four differential values for each of the co-scheduled physical data channels. For example, two bits as “00” may indicate the first value of the set (i.e., 0), two bits as “01” may indicate the second value of the set (i.e., +1), two bits as “10” may indicate the third value of the set (i.e., +2), and two bits as “11” may indicate the fourth value of the set (i.e., +3). When 4 cells (e.g., CC 332-CC 335 in FIG. 3) are co-scheduled by a DCI format on CC 331, denoting the value of the reference HARQ process number as h, which is also the HARQ process number for reference physical data channel on the reference cell (e.g., transmission 321 on CC 332 in FIG. 3), and h2, h3 and h4 are three HARQ process numbers for the remaining three scheduled cells (e.g., CC 333-CC 335 in FIG. 3) respectively, in the case that h=1, h2=2, h3=3, h4=4, the BS can indicate the value of the reference HARQ process number as 1, so that the values of h2-h, h3-h and h4-h can be indicated in the DCI format by pointing out the differential values from the set of possible differential values, respectively. For example, the differential value for HARQ process number of the 2^{nd} scheduled physical data channel (e.g., transmission 322 on CC 333 in FIG. 3) is +1, which can be indicated by two bits as “01”, the differential value for HARQ process number of the 3^{rd} scheduled physical data channel (e.g., transmission 323 on CC 334 in FIG. 3) is +2, which can be indicated by two bits as “10”, and the differential value for HARQ process number of the 4th scheduled physical data channel (e.g., transmission 324 on CC 335 in FIG. 3) is +3, which can be indicated by two bits as “11”. In this example, a total of 10 bits may be needed, i.e., 4 bits indicating the value of the reference HARQ process number, and 6 bits indicating the 3 differential values for 3 HARQ process numbers of the 4 co-scheduled physical data channels except the reference physical data channel, with every two consecutive bits of the 6 bits corresponding to one of the 4 co-scheduled physical data channels except the reference physical data channel.

For example, the reference cell may be defined as the cell where the DCI format is transmitted and the reference physical data channel may be the scheduled physical data channel on the reference cell. Referring back to FIG. 4, the reference cell may be CC 433 and the reference physical data channel is transmission 423 on CC 433. Assuming that a set of possible differential values is {0, +1, +2, +3} and 16 HARQ processes are configured per co-scheduled cell, then 4 bits may be needed to indicate the reference HARQ process number and 2 bits may be needed to indicate one of the four differential values for each of the co-scheduled physical data channels. For example, two bits as “00” may indicate the first value of the set (i.e., 0), two bits as “01” may indicate the second value of the set (i.e., +1), two bits as “10” may indicate the third value of the set (i.e., +2), and two bits as “11” may indicate the fourth value of the set (i.e., +3). When 4 cells (e.g., CC 431-CC 434 in FIG. 4) are co-scheduled by a DCI format on CC 433, denoting the value of the reference HARQ process number as h, which is also the HARQ process number for reference physical data channel on the reference cell (e.g., transmission 423 on CC 433 in FIG. 4) and h1, h2 and h4 are three HARQ process numbers for the remaining three scheduled cells (e.g., CC 431, CC 432 and CC 434 in FIG. 4) respectively, in the case that h=1, h1=2, h2-3, h4=4, the BS can indicate the value of the reference HARQ process number as 1, so that the values of h1-h, h2-h and h4-h can be indicated in the DCI format by pointing out the differential values from the set of possible differential values, respectively. For example, the differential value for HARQ process number of the 1^{st} scheduled physical data channel (e.g., transmission 421 on CC 431 in FIG. 4) is +1, which can be indicated by two bits as “01”, the differential value for HARQ process number of the 2^{nd} scheduled physical data channel (e.g., transmission 422 on CC 432 in FIG. 4) is +2, which can be indicated by two bits as “10”, and the differential value for HARQ process number of the 4th scheduled physical data channel (e.g., transmission 424 on CC 434 in FIG. 4) is +3, which can be indicated by two bits as “11”. In this example, a total of 10 bits may be needed, i.e., 4 bits indicating the value of the reference HARQ process number, and 6 bits indicating the 3 differential values for 3 HARQ process numbers of the 4 co-scheduled physical data channels except the reference physical data channel, with every two consecutive bits of the 6 bits corresponding to one of the 4 co-scheduled physical data channels except the reference physical data channel.

For example, the reference cell may be defined as the first scheduled cell indicated by the indicator of co-scheduled cells in the DCI format and the reference physical data channel may be the scheduled physical data channel on the reference cell. Referring back to FIG. 5, the reference cell may be CC 531 and the reference physical data channel is transmission 521 on CC 531. Assuming that a set of possible differential values is {0, +1, +2, +3} and 16 HARQ processes are configured per co-scheduled cell, then 4 bits may be needed to indicate the reference HARQ process number and 2 bits may be needed to indicate one of the four differential values for each of the co-scheduled physical data channels. For example, two bits as “00” may indicate the first value of the set (i.e., 0), two bits as “01” may indicate the second value of the set (i.e., +1), two bits as “10” may indicate the third value of the set (i.e., +2), and two bits as “11” may indicate the fourth value of the set (i.e., +3). When 4 cells (e.g., CC 531, CC 532, CC 534, and CC 535 in FIG. 5) are co-scheduled by a DCI format on CC 533, denoting the value of the reference HARQ process number as h, which is also the HARQ process number for the reference physical data channel on the reference cell (e.g., transmission 521 on CC 531 in FIG. 5), and h2, h3 and h4 are three HARQ process numbers for the remaining three scheduled cells (e.g., CC 532, CC 534, and CC 535 in FIG. 5) respectively, in the case that h=1, h2=2, h3=3, h4=4, the BS can indicate the value of the reference HARQ process number as 1, so that the values of h2-h, h3-h and h4-h can be indicated in the DCI format by pointing out the differential values from the set of possible differential values, respectively. For example, the differential value for HARQ process number of the 2^{nd} scheduled physical data channel (e.g., transmission 522 on CC 532 in FIG. 5) is +1, which can be indicated by two bits as “01”, the differential value for HARQ process number of the 3^{rd} scheduled physical data channel (e.g., transmission 523 on CC 534 in FIG. 5) is +2, which can be indicated by two bits as “10”, and the differential value for HARQ process number of the 4th scheduled physical data channel (e.g., transmission 524 on CC 535 in FIG. 5) is +3, which can be indicated by two bits as “11”. In this example, a total of 10 bits may be needed, i.e., 4 bits indicating the value of the reference HARQ process number, and 6 bits indicating the 3 differential values for 3 HARQ process numbers of the 4 co-scheduled physical data channels except the reference physical data channel with every two consecutive bits corresponding to one of the 4 co-scheduled physical data channels except the reference physical data channel.

In some embodiments of the present disclosure, considering the number of actually co-scheduled cells by a DCI format may be smaller than the maximum number of cells schedulable by the DCI format, a dynamic switch between joint indication and direct indication may be supported to allow a more flexible scheduling. Direct indication means that the value of a HARQ process number of a scheduled cell or scheduled physical data channel is directly indicated in the DCI format.

In some embodiments, whether the dynamic switch is enabled or disabled may be configured by RRC signaling. In some embodiments, the dynamic switch may be predefined as enabled (or supported) in, for example, a standard. In some embodiments, when the dynamic switch is disabled of unsupported, the joint indication as described above with respect to indicator #1 and indicator #2 may be applied. When the dynamic switch is enabled, the bits for the joint HARQ process number indication field may be used for only joint indication, only direct indication, or a combination of joint indication and direct indication under different scenarios.

In some embodiments of the present disclosure, when a DCI format only schedules a single cell for transmitting a single physical data channel (e.g., PDSCH or PUSCH), the HARQ process number of the scheduled single physical data channel is directly indicated in the joint HARQ process number indication field. For example, the single HARQ process number may occupy 4 bits and the remaining unused bits for the field may be reserved in the DCI format.

The dynamic switch, if enabled, may be implemented in various manners.

In some embodiments of the present disclosure, a UE may determine the number of actually co-scheduled cells based on the DCI format (e.g., an indicator of co-scheduled cells in the DCI format). When the UE determines that the number of actually co-scheduled cells is equal to the maximum number of co-schedulable cells for the UE, the UE assumes that only the joint indication method is adopted. That is, indicator #1 and indicator #2 jointly indicate the plurality of HARQ process numbers of the plurality of co-scheduled physical data channels.

When the UE determines that the number of actually co-scheduled cells is smaller than the maximum number of co-schedulable cells for the UE and the number of bits for the joint HARQ process number indication field (e.g., K′+(M′−1)*[log₂ N′] bits) is sufficient to directly indicate the HARQ process numbers of all co-scheduled physical data channels, the UE assumes that only the direct indication method is adopted. That is, the bits for the joint HARQ process number indication field are used to directly indicate the plurality of HARQ process numbers of the plurality of co-scheduled physical data channels.

For example, when K′+(M′−1)*[log₂ N′]>=k₁′+k₂′+ . . . +kₘ′, wherein m is the number of actually co-scheduled cells by the DCI format and kᵢ′ (i={1, 2, . . . , m}) is the number of bits required for indicating the HARQ process number of the i^{th} co-scheduled physical data channel of the m actually co-scheduled physical data channels on the m actually co-scheduled cells, the joint HARQ process number indication field directly indicates the HARQ process numbers of the m actually co-scheduled physical data channels. For example, in the case that the number of bits required for indicating the HARQ process number of each of the actually co-scheduled physical data channels (denotes as “k”) are the same (e.g., the maximum HARQ process supported by each co-scheduled cell are the same), when K′+(M′−1)*[log₂ N′]>=k′*m, the joint HARQ process number indication field directly indicates the HARQ process numbers of the actually co-scheduled physical data channels.

In some embodiments of the present disclosure, when the UE determines that the number of actually co-scheduled cells is smaller than the maximum number of co-scheduled cells for the UE while the number of bits for the joint HARQ process number indication field is not sufficient to directly indicate the HARQ process numbers of all co-scheduled physical data channels (e.g., K′+(M′−1)*[log₂ N′]<k₁′+k₂′+ . . . +kₘ′, or K′+(M′−1)*[log₂ N′]<k′*m), the UE assumes that only the joint indication method is adopted. That is, indicator #1 and indicator #2 jointly indicate the plurality of HARQ process numbers of the plurality of co-scheduled physical data channels.

In some embodiments of the present disclosure, when the UE determines that the number of actually co-scheduled cells is smaller than the maximum number of co-scheduled cells for the UE while the number of bits for the joint HARQ process number indication field is not sufficient to directly indicate the HARQ process numbers of all co-scheduled physical data channels (e.g., K′+(M′−1)*[log₂ N′]<k₁′+k₂′+ . . . +kₘ′, or K′+(M′−1)*[log₂ N′]<k′*m), the UE assumes that a combination of the joint indication method and the direct indication method is adopted.

For example, a portion of the bits for the joint HARQ process number indication field may be used to directly indicate a number of HARQ process numbers (e.g., X HARQ process numbers) of the plurality of HARQ process numbers of all co-scheduled physical data channels. The remaining bits for the field may include indicator #1 and indicator #2 jointly indicating the remaining HARQ process numbers (e.g., m−X HARQ process numbers) of the plurality of HARQ process numbers.

In some embodiments, the X HARQ process numbers may be associated with X cells among the plurality of actually co-scheduled cells (or X physical data channels of the plurality of co-scheduled physical data channels). In some examples, the X cells may be the first (or last) X cells among the actually co-scheduled cells arranged according to an order as indicated by an indicator of co-scheduled cells in the DCI format or arranged according to a predefined order (e.g., an ascending or descending order) of indexes of the plurality of actually co-scheduled cells.

In some embodiments, X may be equal to the largest number of HARQ process numbers that can be directly indicated along with the remaining HARQ process numbers of the plurality of HARQ process numbers that can be jointly indicated by indicator #1 and indicator #2 in the remaining bits of the field. For example, X may be the largest integer value satisfying K′+(M′−1)*[log₂ N′]>=k₁′+k₂′+ . . . +kₓ′+K′+(m−1−X)*[log₂ N′] or K′+(M′−1)*[log₂ N′]>=k′*X+K′+ (m−1−X)*[log₂ N′].

For example, assuming M′=4, N′=4, K′=4, then K′+(M′−1)*[log₂ N′]=10. When m=4, then the UE assumes that the joint indication method for indicating the HARQ process numbers of co-scheduled physical data channels is adopted. That is, indicator #1 and indicator #2 jointly indicate the four HARQ process numbers for the four co-scheduled physical data channels. When m=2 and k′=4, then K′+(M′−1)*[log₂ N′]>k′*m. The UE assumes that the direct indication method is adopted. That is, the joint HARQ process number indication field directly indicates the two HARQ process numbers for the two co-scheduled physical data channels, and the unused K′+(M′−1)*[log₂ N′]-k′*m bits are reserved.

When m=3 and k′=4, then K′+(M′−1)*[log₂ N′]<k′*m. In some embodiments, the UE assumes that the joint indication method for indicating the three HARQ process numbers of three co-scheduled physical data channels is adopted. That is, indicator #1 and indicator #2 jointly indicate the three HARQ process numbers of the three co-scheduled physical data channels. For example, indicator #1 indicates a reference HARQ process number of a reference physical data channels of the three co-scheduled physical data channels and indicator #2 indicates the differential values between the reference HARQ process number and the two remaining co-scheduled physical data channels of the three co-scheduled physical data channels.

In some other embodiments, the UE assumes that a combination of the joint indication method and the direct indication method is adopted. For example, the largest integer value of X which satisfies the equation of K′+(M′−1)*[log₂ N′]>=k′*X+K′+(m−1−X)*[log₂ N′] is X=1, so the joint HARQ process number indication field directly indicates one HARQ process number of the three HARQ process numbers of the three co-scheduled physical data channels and includes indicator #1 and indicator #2 for indicating the remaining two HARQ process numbers.

In some examples, the single directly indicated HARQ process number may correspond to the first scheduled cell (or the first physical data channel) among the three co-scheduled cells (or the three physical data channels) as indicated by the indicator of co-scheduled cells in the DCI format. In some examples, the single directly indicated HARQ process number may correspond to a scheduled cell having the highest or lowest cell index among the three co-scheduled cells.

In some embodiments of the present disclosure, the joint HARQ process number indication field may indicate a HARQ process number combination from a set of HARQ process number combinations for the plurality of HARQ process numbers of the plurality of co-scheduled physical data channels.

In some embodiments, the set of HARQ process number combinations may be configured by a BS via, for example, RRC signaling. In some embodiments, the set of HARQ process number combinations may be predefined in, for example, a standard.

In some embodiments, each HARQ process number combination in the set of HARQ process number combinations may include at least one HARQ process number. Each of the at least one HARQ process number of a specific HARQ process number combination may correspond to one of a co-scheduled physical data channels (e.g., in a one-to-one mapping manner). For example, the HARQ process number combination indicated by the joint HARQ process number indication field may include several HARQ process numbers, each of which corresponds to one of a physical data channel scheduled by the DCI format.

The number of bits for the joint HARQ process number indication field in the DCI format may be determined based on the set of HARQ process number combinations. For example, the size of the field is based on the number of HARQ process number combinations in the set of HARQ process number combinations.

In some embodiments, it is assumed that the HARQ process number(s) in a HARQ process number combination is arranged according to an order as indicated by an indicator of co-scheduled cells in the DCI format. In some embodiments, it is assumed that the HARQ process number(s) in a HARQ process number combination is arranged according to a predefined order (e.g., an ascending or descending order) of the indexes of corresponding scheduled cell(s).

For example, assuming that a HARQ process number combination of {x1, x2, x3, x4} is indicated by the field, according to the indicator of co-scheduled cells, x1 is the HARQ process number for the first scheduled physical data channel, x2 is the HARQ process number for the second scheduled physical data channel, x3 is the HARQ process number for the third scheduled physical data channel, and x4 is the HARQ process number for the fourth scheduled physical data channel.

In this way, the HARQ process number for each of the co-scheduled physical data channel can be indicated by the field in the DCI format.

In some embodiments, the set of HARQ process number combinations may include at least one HARQ process number combination which includes a single HARQ process number to support the case of a DCI format scheduling a single cell.

Table 1 below shows an exemplary set of HARQ process number combinations. It should be understood that Table 1 is only for illustrative purposes, and should not be construed as limiting the embodiments of the present disclosure. For example, table 1 assumes that HARQ process number is within 1-16. In some other examples, the HARQ process number may be within the range of 0-15 or other ranges. The third column of Table 1 is for illustrative purpose and may not necessarily be configured or predefined.

TABLE 1
an exemplary set of HARQ process number combinations

| | HARQ | Note: Number of |
|---|---|---|
| | process number | co-scheduled |
| index | combination | cells/channels |
| 0 | {1, 2, 3, 4} | 4 |
| 1 | {3, 4, 5, 6} | 4 |
| 2 | {5, 6, 7, 8} | 4 |
| 3 | {7, 8, 9, 10} | 4 |
| 4 | {9, 10, 11, 12} | 4 |
| 5 | {11, 12, 13, 14} | 4 |
| 6 | {13, 14, 15, 16} | 4 |
| 7 | {1, 2, 9, 10} | 4 |
| 8 | {3, 4, 11, 12} | 4 |
| 9 | {5, 6, 13, 14} | 4 |
| 10 | {7, 8, 15, 16} | 4 |
| . . . | . . . | . . . |
| i | {1, 3, 5} | 3 |
| i + 1 | {5, 7, 9} | 3 |
| i + 2 | {9, 11, 13} | 3 |
| i + 3 | (13, 15, 1} | 3 |
| i + 4 | {2, 4, 6} | 3 |
| i + 5 | {6, 8, 10} | 3 |
| i + 6 | {10, 12, 14} | 3 |
| i + 7 | {14, 16, 2} | 3 |
| . . . | . . . | . . . |
| j | {1, 4} | 2 |
| j + 1 | {2, 6} | 2 |
| j + 2 | {3, 7} | 2 |
| j + 3 | {4, 8} | 2 |
| j + 4 | {5, 10} | 2 |
| j + 5 | {6, 12} | 2 |
| j + 6 | {7, 14} | 2 |
| j + 7 | {8, 16} | 2 |
| . . . | . . . | . . . |
| k | {1} | 1 |
| k + 1 | {2} | 1 |
| k + 2 | {3} | 1 |
| k + 3 | {4} | 1 |
| k + 4 | {8} | 1 |
| k + 5 | {9} | 1 |
| k + 6 | {10} | 1 |
| k + 7 | {11} | 1 |
| . . . | . . . | . . . |

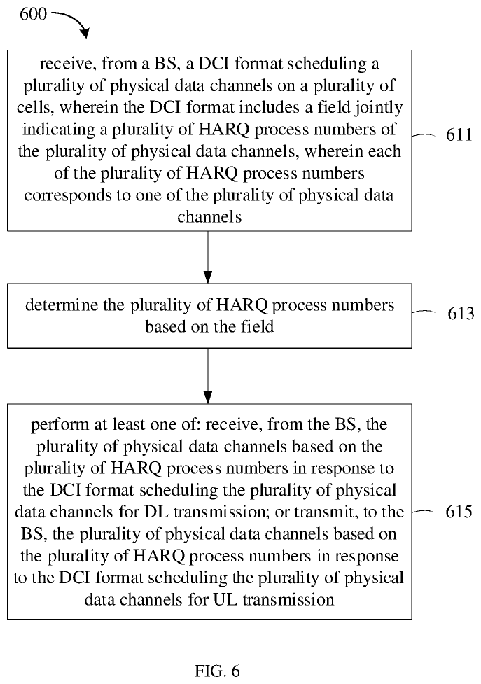

FIG. 6 illustrates a flow chart of an exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a UE, for example, UE 101 in FIG. 1.

Referring to FIG. 6, in operation 611, a UE may receive, from a BS, a DCI format scheduling a plurality of physical data channels on a plurality of cells, wherein the DCI format includes a field jointly indicating a plurality of HARQ process numbers of the plurality of physical data channels, wherein each of the plurality of HARQ process numbers corresponds to one of the plurality of physical data channels.

In operation 613, the UE may determine the plurality of HARQ process numbers based on the field.

In operation 615, the UE may perform at least one of: receive, from the BS, the plurality of physical data channels (e.g., PDSCH) based on the plurality of HARQ process numbers in response to the DCI format scheduling the plurality of physical data channels for DL transmission; or transmit, to the BS, the plurality of physical data channels (e.g., PUSCH) based on the plurality of HARQ process numbers in response to the DCI format scheduling the plurality of physical data channels for UL transmission.

In some embodiments of the present disclosure, the field may include a first indicator (e.g., indicator #1 as described above) indicating a reference HARQ process number for the plurality of HARQ process numbers and a second indicator (e.g., indicator #2 as described above) indicating at least one differential value between the reference HARQ process number and at least one of the plurality of HARQ process numbers.

In some embodiments of the present disclosure, the reference HARQ process number may be: a nearest integer to an average value of the at least one HARQ process number; a median value of the at least one HARQ process number; a minimum value of the at least one HARQ process number; a maximum value of the at least one HARQ process number; or a HARQ process number of a reference physical data channel of the plurality of physical data channels scheduled on a reference cell of the plurality of cells, and the at least one of the plurality of HARQ process numbers does not include the reference HARQ process number.

In some embodiments of the present disclosure, the reference cell is a cell where the DCI format is transmitted, and the reference physical data channel is a physical data channel scheduled on the reference cell.

In some embodiments of the present disclosure, the reference cell is the first scheduled cell among the plurality of cells as indicated by an indicator of co-scheduled cells in the DCI format, and the reference physical data channel is a physical data channel scheduled on the reference cell.

In some embodiments of the present disclosure, the reference cell is a cell with the largest subcarrier spacing among the plurality of cells, and the reference physical data channel is a physical data channel scheduled on the reference cell.

In some embodiments of the present disclosure, the reference cell is a cell with the smallest subcarrier spacing among the plurality of cells, and the reference physical data channel is a physical data channel scheduled on the reference cell.

In some embodiments of the present disclosure, the reference cell is a cell where the last physical data channel of the plurality of physical data channels is transmitted, and the reference physical data channel is a physical data channel scheduled on the reference cell.

In some embodiments of the present disclosure, the reference physical data channel is the last physical data channel of the plurality of physical data channels, and the reference cell is a cell where the reference physical data channel is transmitted.

In some embodiments of the present disclosure, the reference cell is a cell where the earliest physical data channel of the plurality of physical data channels is transmitted, and the reference physical data channel is a physical data channel scheduled on the reference cell.

In some embodiments of the present disclosure, the reference physical data channel is the earliest physical data channel of the plurality of physical data channels, and the reference cell is a cell where the reference physical data channel is transmitted.

In some embodiments of the present disclosure, the reference cell is a cell with the lowest serving cell index among the plurality of cells, and the reference physical data channel is a physical data channel scheduled on the reference cell.

In some embodiments of the present disclosure, the reference cell is a cell with the highest serving cell index among the plurality of cells, and the reference physical data channel is a physical data channel scheduled on the reference cell.

In some embodiments of the present disclosure, in response to the DCI format scheduling the plurality of physical data channels for DL transmission (e.g., PDSCH), the reference physical data channel is a reference physical data channel for determining a slot (e.g., PUCCH slot) for transmitting HARQ-ACK feedback for the plurality of physical data channels, and the reference cell is a reference cell for determining the slot for transmitting HARQ-ACK feedback for the plurality of physical data channels.

In some embodiments of the present disclosure, the second indicator indicates the differential values from at least one set of possible differential values.

In some embodiments, the at least one set of possible differential values may include a plurality of sets of possible differential values, each of which is associated with at least one of the plurality of cells. In some embodiments, the at least one set of possible differential values may include a single set of possible differential values for the plurality of cells.

In some embodiments, separate sets of possible differential values may be applied to the physical data channels for DL transmission and the physical data channels for UL transmission.

In some embodiments, the at least one set of possible differential values is configured by the BS or predefined.

In some embodiments, the number of bits for the second indicator may be based on at least one of: the number of values in the at least one set of possible differential values or a maximum number of cells schedulable by the DCI format. For example, the number of bits for the second indicator may be equal to M*[log₂ N] or (M′−1)*[log₂ N′].

In some embodiments, the second indicator may include a plurality of third indicators (e.g., indicators #3 as described above). Each of the third indicators may indicate a differential value from a corresponding set of possible differential values of at least one set of possible differential values for an associated HARQ process number of the at least one of the plurality of HARQ process numbers.

In some embodiments, the plurality of third indicators may be arranged in the second indicator in an order as indicated by an indicator of co-scheduled cells in the DCI format. In some embodiments, the plurality of third indicators may be arranged in the second indicator according to a predefined order (e.g., an ascending or descending order) of indexes of the corresponding cells.

In some embodiments, determining the plurality of HARQ process numbers may include determining a HARQ process number of the plurality of HARQ process numbers based on the reference HARQ process number and an associated differential value for the HARQ process number.

In some embodiments, the UE may determine whether a number of cells of the plurality of cells is equal to or smaller than a maximum number of cells schedulable by the DCI format.

In response to determining that the number of cells of the plurality of cells is equal to the maximum number of cells schedulable by the DCI format, the first indicator and the second indicator may jointly indicate the plurality of HARQ process numbers.

In response to determining that the number of cells of the plurality of cells is smaller than the maximum number of cells schedulable by the DCI format, the UE may determine whether a number of bits for the field is sufficient to directly indicate the plurality of HARQ process numbers.

In response to determining that the number of bits for the field is sufficient to directly indicate the plurality of HARQ process numbers, the bits for the field may be used to directly indicate the plurality of HARQ process numbers.

In some embodiments, in response to determining that the number of bits for the field is not sufficient to directly indicate the plurality of HARQ process numbers, the first indicator and the second indicator may jointly indicate the plurality of HARQ process numbers.

In some embodiments, in response to determining that the number of bits for the field is not sufficient to directly indicate the plurality of HARQ process numbers, a portion of the bits for the field may be used to directly indicate X HARQ process numbers of the plurality of HARQ process numbers, and the remaining bits for the field may include the first indicator and the second indicator jointly indicating the remaining HARQ process numbers of the plurality of HARQ process numbers.

In some embodiments, the X HARQ process numbers may be associated with X cells among the plurality of cells. In some embodiments, the X cells may be the first (or last) X cells among the plurality of cells arranged according to an order as indicated by an indicator of co-scheduled cells in the DCI format. In some embodiments, the X cells may be the first (or last) X cells among the plurality of cells arranged according to a predefined order (e.g., an ascending or descending order) of indexes of the plurality of cells.

In some embodiments, X may be equal to a largest number of HARQ process numbers that can be directly indicated along with the remaining HARQ process numbers of the plurality of HARQ process numbers that can be jointly indicated by the first indicator and the second indicator in the remaining bits of the field.

In some embodiments, determining whether the number of cells of the plurality of cells is equal to or smaller than the maximum number of cells schedulable by the DCI format may include determining whether the number of cells of the plurality of cells is equal to or smaller than the maximum number of cells schedulable by the DCI format when a dynamic switch between joint indication and direct indication for the plurality of HARQ process numbers is enabled. In some embodiments, the dynamic switch may be enabled or disabled by RRC signaling. In some embodiments, the dynamic switch may be predefined as enabled.

In some embodiments of the present disclosure, the field may indicate a HARQ process number combination from a set of HARQ process number combinations for the plurality of HARQ process numbers. In some embodiments, the set of HARQ process number combinations may be configured by the BS or predefined. In some embodiments, each HARQ process number combination in the set of HARQ process number combinations may include at least one HARQ process number. In some embodiments, the size of the field may be based on the number of HARQ process number combinations in the set of HARQ process number combinations.

In some embodiments, the plurality of HARQ process numbers in the HARQ process number combination may be arranged according to an order as indicated by an indicator of co-scheduled cells in the DCI format. In some embodiments, the plurality of HARQ process numbers in the HARQ process number combination may be arranged according to a predefined order (e.g., an ascending or descending order) of indexes of the plurality of cells.

It should be appreciated by persons skilled in the art that the sequence of the operations in exemplary procedure 600 may be changed and some of the operations in exemplary procedure 600 may be eliminated or modified, without departing from the spirit and scope of the disclosure.

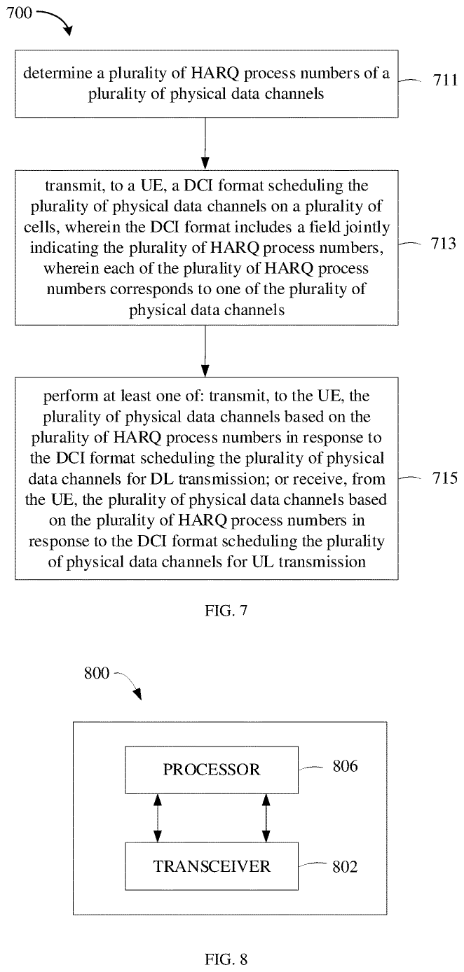

FIG. 7 illustrates a flow chart of an exemplary procedure 700 for wireless communications in accordance with some embodiments of the present disclosure. Details described in all of the foregoing embodiments of the present disclosure are applicable for the embodiments shown in FIG. 7. In some examples, the procedure may be performed by a BS, for example, BS 102 in FIG. 1.

Referring to FIG. 7, in operation 711, a BS may determine a plurality of HARQ process numbers of a plurality of physical data channels.

In operation 713, the BS may transmit, to a UE, a DCI format scheduling the plurality of physical data channels on a plurality of cells, wherein the DCI format includes a field jointly indicating the plurality of HARQ process numbers, wherein each of the plurality of HARQ process numbers corresponds to one of the plurality of physical data channels.

In operation 715, the BS may perform at least one of: transmit, to the UE, the plurality of physical data channels based on the plurality of HARQ process numbers in response to the DCI format scheduling the plurality of physical data channels for DL transmission; or receive, from the UE, the plurality of physical data channels based on the plurality of HARQ process numbers in response to the DCI format scheduling the plurality of physical data channels for UL transmission.

In some embodiments of the present disclosure, the field may include a first indicator (e.g., indicator #1 as described above) indicating a reference HARQ process number for the plurality of HARQ process numbers and a second indicator (e.g., indicator #2 as described above) indicating at least one differential value between the reference HARQ process number and at least one of the plurality of HARQ process numbers.

In some embodiments of the present disclosure, the reference HARQ process number may be: a nearest integer to an average value of the at least one HARQ process number; a median value of the at least one HARQ process number; a minimum value of the at least one HARQ process number; a maximum value of the at least one HARQ process number; or a HARQ process number of a reference physical data channel of the plurality of physical data channels scheduled on a reference cell of the plurality of cells, and the at least one of the plurality of HARQ process numbers does not include the reference HARQ process number.

In some embodiments of the present disclosure, the reference cell is a cell where the DCI format is transmitted, and the reference physical data channel is a physical data channel scheduled on the reference cell.

In some embodiments of the present disclosure, the reference cell is the first scheduled cell among the plurality of cells as indicated by an indicator of co-scheduled cells in the DCI format, and the reference physical data channel is a physical data channel scheduled on the reference cell.

In some embodiments of the present disclosure, the reference cell is a cell with the largest subcarrier spacing among the plurality of cells, and the reference physical data channel is a physical data channel scheduled on the reference cell.

In some embodiments of the present disclosure, the reference cell is a cell with the smallest subcarrier spacing among the plurality of cells, and the reference physical data channel is a physical data channel scheduled on the reference cell.

In some embodiments of the present disclosure, the reference cell is a cell where the last physical data channel of the plurality of physical data channels is transmitted, and the reference physical data channel is a physical data channel scheduled on the reference cell.

In some embodiments of the present disclosure, the reference physical data channel is the last physical data channel of the plurality of physical data channels, and the reference cell is a cell where the reference physical data channel is transmitted.

In some embodiments of the present disclosure, the reference cell is a cell where the earliest physical data channel of the plurality of physical data channels is transmitted, and the reference physical data channel is a physical data channel scheduled on the reference cell.

In some embodiments of the present disclosure, the reference physical data channel is the earliest physical data channel of the plurality of physical data channels, and the reference cell is a cell where the reference physical data channel is transmitted.

In some embodiments of the present disclosure, the reference cell is a cell with the lowest serving cell index among the plurality of cells, and the reference physical data channel is a physical data channel scheduled on the reference cell.

In some embodiments of the present disclosure, the reference cell is a cell with the highest serving cell index among the plurality of cells, and the reference physical data channel is a physical data channel scheduled on the reference cell.

In some embodiments of the present disclosure, in response to the DCI format scheduling the plurality of physical data channels for DL transmission (e.g., PDSCH), the reference physical data channel is a reference physical data channel for determining a slot (e.g., PUCCH slot) for transmitting HARQ-ACK feedback for the plurality of physical data channels, and the reference cell is a reference cell for determining the slot for transmitting HARQ-ACK feedback for the plurality of physical data channels.

In some embodiments of the present disclosure, the second indicator indicates the differential values from at least one set of possible differential values.

In some embodiments, the BS may determine the reference HARQ process number based on the at least one set of possible differential values and the at least one HARQ process number.

In some embodiments, the at least one set of possible differential values may include a plurality of sets of possible differential values, each of which is associated with at least one of the plurality of cells. In some embodiments, the at least one set of possible differential values may include a single set of possible differential values for the plurality of cells.

In some embodiments, separate sets of possible differential values may be applied to the physical data channels for DL transmission and the physical data channels for UL transmission.

In some embodiments, the at least one set of possible differential values is predefined. In some embodiments, the BS may transmit the at least one set of possible differential values to the UE.

In some embodiments, the number of bits for the second indicator may be based on at least one of: the number of values in the at least one set of possible differential values or a maximum number of cells schedulable by the DCI format. For example, the number of bits for the second indicator may be equal to M*[log₂ N] or (M′−1)*[log₂ N′].

In some embodiments, the second indicator may include a plurality of third indicators (e.g., indicators #3 as described above). Each of the third indicators may indicate a differential value from a corresponding set of possible differential values of at least one set of possible differential values for an associated HARQ process number of the at least one of the plurality of HARQ process numbers.

In some embodiments, the plurality of third indicators may be arranged in the second indicator in an order as indicated by an indicator of co-scheduled cells in the DCI format. In some embodiments, the plurality of third indicators may be arranged in the second indicator according to a predefined order (e.g., an ascending or descending order) of indexes of the corresponding cells.

In some embodiments, the BS may determine a differential value for a HARQ process number based on the HARQ process number and the reference HARQ process number.

In some embodiments, the BS may determine whether a number of cells of the plurality of cells is equal to or smaller than a maximum number of cells schedulable by the DCI format.

In response to determining that the number of cells of the plurality of cells is equal to the maximum number of cells schedulable by the DCI format, the first indicator and the second indicator may jointly indicate the plurality of HARQ process numbers.

In response to determining that the number of cells of the plurality of cells is smaller than the maximum number of cells schedulable by the DCI format, the BS may determine whether a number of bits for the field is sufficient to directly indicate the plurality of HARQ process numbers.

In response to determining that the number of bits for the field is sufficient to directly indicate the plurality of HARQ process numbers, the bits for the field may be used to directly indicate the plurality of HARQ process number.

In some embodiments, in response to determining that the number of bits for the field is not sufficient to directly indicate the plurality of HARQ process numbers, the first indicator and the second indicator may jointly indicate the plurality of HARQ process numbers.

In some embodiments, in response to determining that the number of bits for the field is not sufficient to directly indicate the plurality of HARQ process numbers, a portion of the bits for the field may be used to directly indicate X HARQ process numbers of the plurality of HARQ process numbers, and the remaining bits for the field may include the first indicator and the second indicator jointly indicating the remaining HARQ process numbers of the plurality of HARQ process numbers.

In some embodiments, the X HARQ process numbers may be associated with X cells among the plurality of cells. In some embodiments, the X cells may be the first (or last) X cells among the plurality of cells arranged according to an order as indicated by an indicator of co-scheduled cells in the DCI format. In some embodiments, the X cells may be the first (or last) X cells among the plurality of cells arranged according to a predefined order (e.g., an ascending or descending order) of indexes of the plurality of cells.

In some embodiments, X may be equal to a largest number of HARQ process numbers that can be directly indicated along with the remaining HARQ process numbers of the plurality of HARQ process numbers that can be jointly indicated by the first indicator and the second indicator in the remaining bits of the field.

In some embodiments, determining whether the number of cells of the plurality of cells is equal to or smaller than the maximum number of cells schedulable by the DCI format may include determining whether the number of cells of the plurality of cells is equal to or smaller than the maximum number of cells schedulable by the DCI format when a dynamic switch between joint indication and direct indication for the plurality of HARQ process numbers is enabled for the UE.

In some embodiments, the dynamic switch may be enabled or disabled by RRC signaling. In some embodiments, the dynamic switch may be predefined as enabled.

In some embodiments, the field may indicate a HARQ process number combination from a set of HARQ process number combinations for the plurality of HARQ process numbers.

In some embodiments, the set of HARQ process number combinations may be predefined. In some embodiments, the BS may transmit the set of HARQ process number combinations to the UE.

In some embodiments, each HARQ process number combination in the set of HARQ process number combinations may include at least one HARQ process number.

In some embodiments, the size of the field may be based on the number of HARQ process number combinations in the set of HARQ process number combinations.

In some embodiments, the plurality of HARQ process numbers in the HARQ process number combination may be arranged according to an order as indicated by an indicator of co-scheduled cells in the DCI format. In some embodiments, the plurality of HARQ process numbers in the HARQ process number combination may be arranged according to a predefined order (e.g., an ascending or descending order) of indexes of the plurality of cells.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a block diagram of an exemplary apparatus 800 according to some embodiments of the present disclosure. As shown in FIG. 8, the apparatus 800 may include at least one processor 806 and at least one transceiver 802 coupled to the processor 806. The apparatus 800 may be a UE or a BS.

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other so as to perform the operations with respect to the UE described in FIGS. 1-7. In some embodiments of the present application, the apparatus 800 may be a BS. The transceiver 802 and the processor 806 may interact with each other so as to perform the operations with respect to the BS described in FIGS. 1-7.

In some embodiments of the present application, the apparatus 800 may further include at least one non-transitory computer-readable medium.

For example, in some embodiments of the present disclosure, the non-transitory computer-readable medium may have stored thereon computer-executable instructions to cause the processor 806 to implement the method with respect to the UE as described above. For example, the computer-executable instructions, when executed, cause the processor 806 interacting with transceiver 802 to perform the operations with respect to the UE described in FIGS. 1-7.

In some embodiments of the present disclosure, the non-transitory computer-readable medium may have stored thereon computer-executable instructions to cause the processor 806 to implement the method with respect to the BS as described above. For example, the computer-executable instructions, when executed, cause the processor 806 interacting with transceiver 802 to perform the operations with respect to the BS described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive, from a base station, a downlink control information (DCI) format scheduling a plurality of physical data channels on a plurality of cells, wherein the DCI format includes a field jointly indicating a plurality of hybrid automatic repeat request (HARQ) process numbers of the plurality of physical data channels, wherein each of the plurality of HARQ process numbers corresponds to one of the plurality of physical data channels;
determine the plurality of HARQ process numbers based on the field; and
at least one of:
receive, from the base station, the plurality of physical data channels based on the plurality of HARQ process numbers in response to the DCI format scheduling the plurality of physical data channels for downlink (DL) transmission; or
transmit, to the base station, the plurality of physical data channels based on the plurality of HARQ process numbers in response to the DCI format scheduling the plurality of physical data channels for uplink (UL) transmission.

2. The UE of claim 1, wherein the field comprises a first indicator indicating a reference HARQ process number for the plurality of HARQ process numbers and a second indicator indicating at least one differential value between the reference HARQ process number and at least one of the plurality of HARQ process numbers.

3. The UE of claim 2, wherein the reference HARQ process number is:
a nearest integer to an average value of the at least one HARQ process number;
a median value of the at least one HARQ process number;
a minimum value of the at least one HARQ process number;
a maximum value of the at least one HARQ process number; or
a HARQ process number of a reference physical data channel of the plurality of physical data channels scheduled on a reference cell of the plurality of cells, and the at least one of the plurality of HARQ process numbers does not include the reference HARQ process number.

4. The UE of claim 3, wherein the reference cell is a cell where the DCI format is transmitted, and the reference physical data channel is a physical data channel scheduled on the reference cell; or
wherein the reference cell is a first scheduled cell among the plurality of cells as indicated by an indicator of co-scheduled cells in the DCI format, and the reference physical data channel is a physical data channel scheduled on the reference cell; or
wherein the reference cell is a cell with the largest subcarrier spacing among the plurality of cells, and the reference physical data channel is a physical data channel scheduled on the reference cell; or
wherein the reference cell is a cell with the smallest subcarrier spacing among the plurality of cells, and the reference physical data channel is a physical data channel scheduled on the reference cell; or
wherein the reference cell is a cell where the last physical data channel of the plurality of physical data channels is transmitted, and the reference physical data channel is a physical data channel scheduled on the reference cell; or
wherein the reference physical data channel is the last physical data channel of the plurality of physical data channels, and the reference cell is a cell where the reference physical data channel is transmitted; or
wherein the reference cell is a cell where the earliest physical data channel of the plurality of physical data channels is transmitted, and the reference physical data channel is a physical data channel scheduled on the reference cell; or
wherein the reference physical data channel is the earliest physical data channel of the plurality of physical data channels, and the reference cell is a cell where the reference physical data channel is transmitted; or
wherein the reference cell is a cell with the lowest serving cell index among the plurality of cells, and the reference physical data channel is a physical data channel scheduled on the reference cell; or
wherein the reference cell is a cell with the highest serving cell index among the plurality of cells, and the reference physical data channel is a physical data channel scheduled on the reference cell; or
wherein in response to the DCI format scheduling the plurality of physical data channels for DL transmission, the reference physical data channel is a reference physical data channel for determining a slot for transmitting HARQ acknowledgement (HARQ-ACK) feedback for the plurality of physical data channels, and the reference cell is a reference cell for determining the slot for transmitting HARQ-ACK feedback for the plurality of physical data channels.

5. The UE of claim 2, wherein the second indicator indicates the differential values from at least one set of possible differential values.

6. The UE of claim 5, wherein the at least one set of possible differential values comprises a plurality of sets of possible differential values, each of which is associated with at least one of the plurality of cells; or
wherein the at least one set of possible differential values comprises a single set of possible differential values for the plurality of cells.

7. The UE of claim 5, wherein a number of bits for the second indicator is based on at least one of: the number of values in the at least one set of possible differential values or a maximum number of cells schedulable by the DCI format.

8. The UE of claim 2, wherein the second indicator comprises a plurality of third indicators, each of which indicates a differential value from a corresponding set of possible differential values of at least one set of possible differential values for an associated HARQ process number of the at least one of the plurality of HARQ process numbers.

9. The UE of claim 8, wherein determining the plurality of HARQ process numbers comprises determining a HARQ process number of the plurality of HARQ process numbers based on the reference HARQ process number and an associated differential value for the HARQ process number.

10. The UE of claim 2, wherein the at least one processor is configured to cause the UE to determine whether a number of cells of the plurality of cells is equal to or smaller than a maximum number of cells schedulable by the DCI format; and
wherein in response to determining that the number of cells of the plurality of cells is equal to the maximum number of cells schedulable by the DCI format, the first indicator and the second indicator jointly indicate the plurality of HARQ process numbers.

11. The UE of claim 10, wherein the at least one processor is configured to cause the UE to, in response to determining that the number of cells of the plurality of cells is smaller than the maximum number of cells schedulable by the DCI format, determine whether a number of bits for the field is sufficient to directly indicate the plurality of HARQ process numbers;
wherein in response to determining that the number of bits for the field is sufficient to directly indicate the plurality of HARQ process numbers, the bits for the field are used to directly indicate the plurality of HARQ process numbers; and
wherein in response to determining that the number of bits for the field is not sufficient to directly indicate the plurality of HARQ process numbers,
the first indicator and the second indicator jointly indicate the plurality of HARQ process numbers, or
a portion of the bits for the field is used to directly indicate X HARQ process numbers of the plurality of HARQ process numbers, and the remaining bits for the field comprise the first indicator and the second indicator jointly indicating the remaining HARQ process numbers of the plurality of HARQ process numbers.

12. The UE of claim 10, wherein determining whether the number of cells of the plurality of cells is equal to or smaller than the maximum number of cells schedulable by the DCI format comprises determining whether the number of cells of the plurality of cells is equal to or smaller than the maximum number of cells schedulable by the DCI format when a dynamic switch between joint indication and direct indication for the plurality of HARQ process numbers is enabled.

13. The UE of claim 1, wherein the field indicates a HARQ process number combination from a set of HARQ process number combinations for the plurality of HARQ process numbers.

14. A base station (BS), comprising:
a transceiver; and
a processor coupled to the transceiver, wherein the processor is configured to:
at least one memory; and
at least one processor coupled with the at least one memory and configured to cause the base station to:
determine a plurality of hybrid automatic repeat request (HARQ) process numbers of a plurality of physical data channels;
transmit, to a user equipment (UE), a downlink control information (DCI) format scheduling the plurality of physical data channels on a plurality of cells, wherein the DCI format includes a field jointly indicating the plurality of HARQ process numbers, wherein each of the plurality of HARQ process numbers corresponds to one of the plurality of physical data channels; and
at least one of:
transmit, to the UE, the plurality of physical data channels based on the plurality of HARQ process numbers in response to the DCI format scheduling the plurality of physical data channels for downlink (DL) transmission; or
receive, from the UE, the plurality of physical data channels based on the plurality of HARQ process numbers in response to the DCI format scheduling the plurality of physical data channels for uplink (UL) transmission.

15. A method performed by a user equipment (UE), the method comprising:
receiving, from a base station (BS), a downlink control information (DCI) format scheduling a plurality of physical data channels on a plurality of cells, wherein the DCI format includes a field jointly indicating a plurality of hybrid automatic repeat request (HARQ) process numbers of the plurality of physical data channels, wherein each of the plurality of HARQ process numbers corresponds to one of the plurality of physical data channels;
determining the plurality of HARQ process numbers based on the field; and
at least one of:
receiving, from the base station, the plurality of physical data channels based on the plurality of HARQ process numbers in response to the DCI format scheduling the plurality of physical data channels for downlink (DL) transmission; or
transmitting, to the base station, the plurality of physical data channels based on the plurality of HARQ process numbers in response to the DCI format scheduling the plurality of physical data channels for uplink (UL) transmission.

16. A processor for wireless communication, comprising:
at least one controller coupled with at least one memory and configured to cause the processor to:
receive, from a base station, a downlink control information (DCI) format scheduling a plurality of physical data channels on a plurality of cells, wherein the DCI format includes a field jointly indicating a plurality of hybrid automatic repeat request (HARQ) process numbers of the plurality of physical data channels, wherein each of the plurality of HARQ process numbers corresponds to one of the plurality of physical data channels;
determine the plurality of HARQ process numbers based on the field; and
at least one of:
receive, from the base station, the plurality of physical data channels based on the plurality of HARQ process numbers in response to the DCI format scheduling the plurality of physical data channels for downlink (DL) transmission; or
transmit, to the base station, the plurality of physical data channels based on the plurality of HARQ process numbers in response to the DCI format scheduling the plurality of physical data channels for uplink (UL) transmission.

17. The processor of claim 16, wherein the field comprises a first indicator indicating a reference HARQ process number for the plurality of HARQ process numbers and a second indicator indicating at least one differential value between the reference HARQ process number and at least one of the plurality of HARQ process numbers.

18. The processor of claim 17, wherein the reference HARQ process number is:
a nearest integer to an average value of the at least one HARQ process number;
a median value of the at least one HARQ process number;
a minimum value of the at least one HARQ process number;
a maximum value of the at least one HARQ process number; or
a HARQ process number of a reference physical data channel of the plurality of physical data channels scheduled on a reference cell of the plurality of cells, and the at least one of the plurality of HARQ process numbers does not include the reference HARQ process number.

19. The processor of claim 18, wherein the reference cell is a cell where the DCI format is transmitted, and the reference physical data channel is a physical data channel scheduled on the reference cell; or
wherein the reference cell is a first scheduled cell among the plurality of cells as indicated by an indicator of co-scheduled cells in the DCI format, and the reference physical data channel is a physical data channel scheduled on the reference cell; or
wherein the reference cell is a cell with the largest subcarrier spacing among the plurality of cells, and the reference physical data channel is a physical data channel scheduled on the reference cell; or
wherein the reference cell is a cell with the smallest subcarrier spacing among the plurality of cells, and the reference physical data channel is a physical data channel scheduled on the reference cell; or
wherein the reference cell is a cell where the last physical data channel of the plurality of physical data channels is transmitted, and the reference physical data channel is a physical data channel scheduled on the reference cell; or
wherein the reference physical data channel is the last physical data channel of the plurality of physical data channels, and the reference cell is a cell where the reference physical data channel is transmitted; or
wherein the reference cell is a cell where the earliest physical data channel of the plurality of physical data channels is transmitted, and the reference physical data channel is a physical data channel scheduled on the reference cell; or
wherein the reference physical data channel is the earliest physical data channel of the plurality of physical data channels, and the reference cell is a cell where the reference physical data channel is transmitted; or
wherein the reference cell is a cell with the lowest serving cell index among the plurality of cells, and the reference physical data channel is a physical data channel scheduled on the reference cell; or
wherein the reference cell is a cell with the highest serving cell index among the plurality of cells, and the reference physical data channel is a physical data channel scheduled on the reference cell; or
wherein in response to the DCI format scheduling the plurality of physical data channels for DL transmission, the reference physical data channel is a reference physical data channel for determining a slot for transmitting HARQ acknowledgement (HARQ-ACK) feedback for the plurality of physical data channels, and the reference cell is a reference cell for determining the slot for transmitting HARQ-ACK feedback for the plurality of physical data channels.

20. The processor of claim 17, wherein the second indicator indicates the differential values from at least one set of possible differential values.
